(19) United States
(12) Patent Application Publication
(10) Pub. No.: US 2025/0063195 A1
(43) Pub. Date: Feb. 20, 2025

(54) POINT CLOUD PROCESSING METHOD AND APPARATUS, DEVICE, STORAGE MEDIUM, AND PRODUCT

(71) Applicant: TENCENT TECHNOLOGY (SHENZHEN) COMPANY LIMITED, Shenzhen (CN)

(72) Inventor: Wenjie Zhu, Shenzhen (CN)

(73) Assignee: TENCENT TECHNOLOGY (SHENZHEN) COMPANY LIMITED, Shenzhen (CN)

(21) Appl. No.: 18/935,928

(22) Filed: Nov. 4, 2024

Related U.S. Application Data
(63) Continuation of application No. PCT/CN2022/137750, filed on Dec. 9, 2022.

(30) Foreign Application Priority Data
May 6, 2022 (CN) 202210488291.8

(51) Int. Cl. H04N 19/597; H04N 19/18

(52) U.S. Cl. CPC H04N 19/597; H04N 19/18

(57) ABSTRACT

A point cloud processing method, performed by a computer device, includes: setting a limit parameter of a point cloud; obtaining attribute information of a first point of the point cloud to be coded; coding the attribute information of the first point; and transmitting the coded attribute information in a code stream, wherein the coding the attribute information is controlled according to the limit parameter, and wherein the limit parameter includes at least one of a cache limit parameter or a delay limit parameter.

### CROSS-REFERENCE TO RELATED APPLICATIONS

This application is a continuation application of International Application No. PCT/CN2022/137750 filed on Dec. 9, 2022, which claims priority to Chinese Patent Application No. 202210488291.8 filed with the China National Intellectual Property Administration on May 6, 2022, the disclosures of each being incorporated by reference herein in their entireties.

### FIELD

The disclosure relates to the field of computer technologies, to the field of coding and decoding technologies, and to a point cloud processing method, a point cloud processing apparatus, a computer device, a computer-readable storage medium, and a point cloud processing product.

### BACKGROUND

With the continuous development of science and technologies, a large number of high-precision point clouds may be obtained at a low cost and in a short time period. The point cloud may include multiple points. Each point in the point cloud may have geometry information and attribute information. To improve the transmission efficiency of point clouds, however, the point clouds may be coded before transmission. After a coding endpoint codes geometry information and attribute information of each point in the point cloud, the coded point cloud may be transmitted to a decoding endpoint, and the decoding endpoint may decode the coded point cloud to reconstruct geometry information and attribute information of each point in the point cloud. Because the coding process may organize and process the attribute information of each point, the waiting time for coding the attribute information of each point in the point cloud may be long and the coding performance may be low.

### SUMMARY

According to some embodiments, a point cloud processing method, performed by a computer device, includes: setting a limit parameter of a point cloud; obtaining attribute information of a first point of the point cloud to be coded; coding the attribute information of the first point; and transmitting the coded attribute information in a code stream, wherein the coding the attribute information is controlled according to the limit parameter, and wherein the limit parameter includes at least one of a cache limit parameter or a delay limit parameter

According to some embodiments, a point cloud processing apparatus, includes: at least one memory configured to store computer program code; at least one processor configured to read the program code and operate as instructed by the program code, the program code including: setting code configured to cause at least one of the at least one processor to set a limit parameter of a point cloud; obtaining code configured to cause at least one of the at least one processor to obtain attribute information of a first point of the point cloud to be coded; processing code configured to cause at least one of the at least one processor to code the attribute information of the first point; and transmitting code configured to cause at least one of the at least one processor to transmit the coded attribute information in a code stream, wherein the attribute information is coded in a controlled manner according to the limit parameter, and wherein the limit parameter comprises at least one of a cache limit parameter or a delay limit parameter.

According to some embodiments, a non-transitory computer-readable storage medium, storing computer code which, when executed by at least one processor, causes the at least one processor to at least: set a limit parameter of a point cloud; obtain attribute information of a first point of the point cloud to be coded; code the attribute information of the first point; and transmit the coded attribute information in a code stream, wherein the attribute information is coded in a controlled manner according to the limit parameter, and wherein the limit parameter comprises at least one of a cache limit parameter or a delay limit parameter.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1A is a schematic diagram of a coding framework according to some embodiments;

FIG. 1B is a schematic diagram of a neighbor relationship between a block of a current point and a parent block thereof according to some embodiments;

FIG. 2 is an architectural diagram of a point cloud processing system according to some embodiments;

FIG. 3 illustrates a point cloud processing method according to some embodiments;

FIG. 4 illustrates a point cloud processing method according to some embodiments;

FIG. 5 illustrates a point cloud processing method according to some embodiments;

FIG. 6 illustrates a point cloud processing method according to some embodiments;

FIG. 7 is a schematic structural diagram of a point cloud processing apparatus according to some embodiments;

FIG. 8 is a schematic structural diagram of a point cloud processing apparatus according to some embodiments;

FIG. 9 is a schematic structural diagram of a coding device according to some embodiments; and

FIG. 10 is a schematic structural diagram of a decoding device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In order to have a clearer understanding of the technical solution provided in some embodiments, terms involved in some embodiments will be introduced first:
(1) Point Cloud. A point cloud refers to a set of discrete points in irregular distribution in space that express the spatial structure and surface attributes of a three-dimensional object or scene. Point clouds can be divided into different categories according to different classification standards. For example, according to obtaining methods of point clouds, point clouds can be divided into dense point clouds and sparse point clouds. For example, according to time sequence types of point clouds, point clouds can be divided into static point clouds and dynamic point clouds.
(2) Point cloud data. Geometry information and attribute information of each point in the point cloud together constitute point cloud data. Geometry information can also be referred to as three-dimensional position information. Geometry information of a point in the point cloud refers to spatial coordinates (x, y, z) of the point, and can include a coordinate value of the point in each coordinate axis direction of the three-dimensional coordinate system, for example, a coordinate value x in the X-axis direction, a coordinate value y in the Y-axis direction, and a coordinate value z in the Z-axis direction. Attribute information of a point in the point cloud can include at least one of the following: color information, material information, and laser reflection intensity information (which may be also referred to as reflectivity). Usually, each point in the point cloud has the same amount of attribute information. For example, each point in the point cloud can have two types of attribute information: color information and laser reflection intensity information. Each point in the point cloud may have three types of attribute information: color information, material information, and laser reflection intensity information.
(3) Point cloud compression (PCC). Point cloud coding refers to the process of coding the geometry information and attribute information of each point in the point cloud to obtain a compressed code stream. Point cloud coding may include two processes: geometry information coding and attribute information coding. Point cloud coding technology may be divided into geometry-based point cloud coding and projection-based point cloud coding for different types of point clouds. Herein, geometry-based point cloud compression (G-PCC) in moving picture expert group (MPEG) and the point cloud coding standard AVS-PCC in audio video coding standard (AVS) are used as examples.

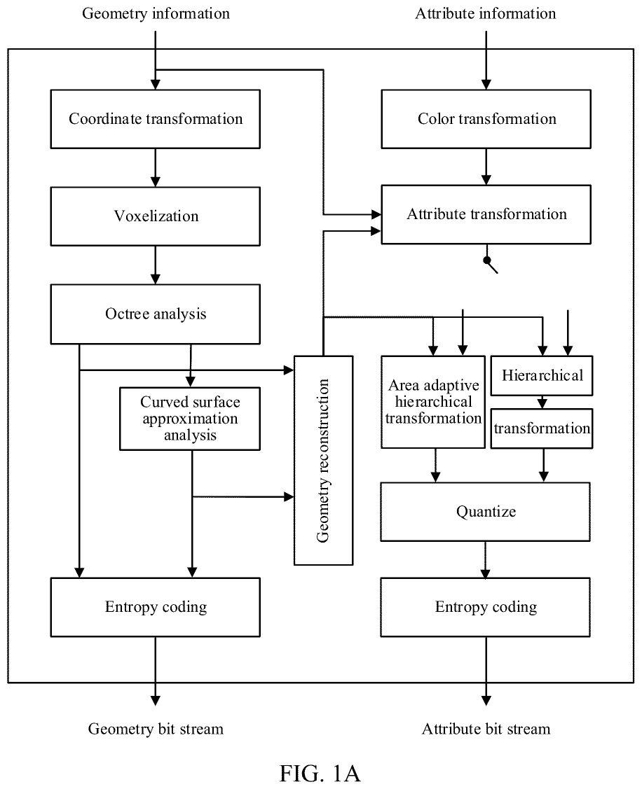

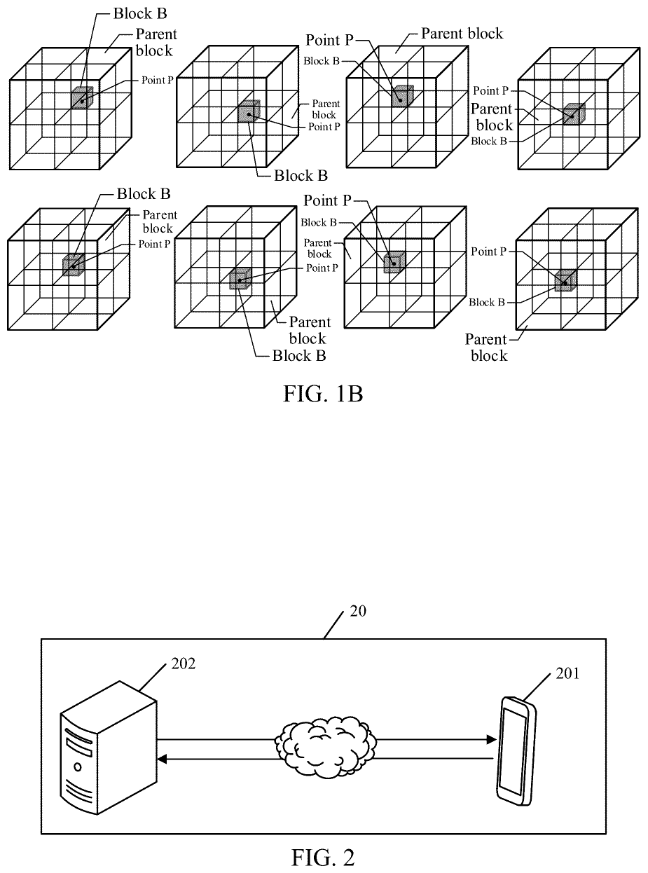

Coding frameworks of G-PCC and AVS-PCC are approximately the same, as shown in FIG. 1A, and can be divided into a geometry information coding process and an attribute information coding process. The geometry information coding process codes geometry information of each point in the point cloud data to obtain a geometry bit stream. The attribute information coding process codes attribute information of each point in the point cloud data to obtain an attribute bit stream. The geometry bit stream and the attribute bit stream together constitute the compressed code stream of the point cloud data.

Operations and processing of the geometry information coding process may include:
1. Pre-Processing: which may include coordinate transform and voxelization. Through scaling and translation operations, point cloud data in the three-dimensional space is converted into an integer form, and the minimum geometry position is moved to the coordinate origin.
2. Geometry octree (Octree) coding: The octree is a tree-shaped data structure. In three-dimensional space division, a preset bounding box is evenly divided, and each node has eight child nodes. “1” and “0” are used to indicate whether each sub-node of the octree is occupied, so that occupancy code information is obtained as the code stream of the point cloud geometry information. A bounding box is an algorithm for solving the optimal bounding space of a discrete point set. Geometry objects may be approximately replaced with slightly larger geometry objects (referred to as bounding boxes) with fewer characteristics.
3. Geometry entropy coding: Statistical compression coding is performed on the occupancy code information of the octree, and a binary (0 or 1) compressed code stream is finally outputted. Statistical coding is a lossless coding scheme that may reduce the bit rate to express the same signal. Content adaptive binary arithmetic coding (CABAC) may be used as a statistical coding scheme.

Operations and processing of the attribute information coding process may include:
1. Attribute recoloring: In the case of lossy coding, based on the geometry information being coded, a coding end may decode and reconstruct the geometry information, for example, restore the geometry information of each point in the point cloud. Attribute information corresponding to one or more adjacent points is found from the original point cloud as the attribute information of the reconstructed point.
2. Transform attribute coding: An attribute transform algorithm (for example, DCT or Haar) is used to group and transform attribute information, and a transform coefficient is quantized. Through inverse quantization and inverse transform, a reconstructed attribute value is obtained. The difference between the original attribute and the reconstructed attribute value is calculated to obtain the attribute residual and the attribute residual is quantized. The quantized transform coefficient and attribute residual are coded.
3. Attribute information quantization: The fineness of quantization may depend on a quantization parameter. In attribute prediction coding, entropy coding is performed on the quantized prediction residual information. In attribute transform coding and attribute prediction transform coding, entropy coding is performed on the quantized transform coefficient.
4. Attribute entropy coding: The quantized prediction residual information or transform coefficient may use run-length coding and arithmetic coding to achieve final compression. Information such as the corresponding coding mode and quantization parameter is also coded by an entropy coder.
(4) Point cloud decoding. Point cloud decoding refers to the process of decoding the compressed code stream obtained by point cloud coding, to reconstruct the point cloud, and refers to the process of reconstructing the geometry information and attribute information of each point in the point cloud based on a geometry bit stream and an attribute bit stream in the compressed code stream. Based on the decoding end obtaining the compressed code stream, entropy decoding is first performed on the geometry bit stream to obtain quantized geometry information of each point in the point cloud, and inverse quantization is performed to reconstruct the geometry information of each point in the point cloud. Entropy decoding is first performed on the attribute bit stream to obtain the quantized prediction residual information or the quantized transform coefficient of each point in the point cloud. Then, the quantized prediction residual information is inversely quantized to obtain the reconstructed residual information, the quantized transform coefficient is inversely quantized to obtain the reconstructed transform coefficient, the reconstructed transform coefficient is inversely transformed to obtain the reconstructed residual information, and the attribute information of each point in the point cloud can be reconstructed according to the reconstructed residual information of each point in the point cloud. One-to-one correspondence between the reconstructed attribute information of each point in the point cloud and the reconstructed geometry information is sequentially established to reconstruct the point cloud.

In addition, the following technologies may be included:

### (1) Attribute Prediction:

1. Point cloud reordering. The process is as follows:

Coordinates (x, y, z) of the point cloud are obtained, Morton codes or Hilbert codes of points are generated based on a space filling curve, and sorting is performed according to a coding order of coding the points (for example, ascending order) to obtain a Morton order or a Hilbert order. Taking the Morton code of geometry coordinates as an example, a geometry position of a point in the point cloud is represented by three-dimensional Cartesian coordinates (X, Y, Z). N bits are used to represent each coordinate value, and coordinates of a k^{th} point (X^{k}, Y^{k}, Z^{k}) can be expressed as:

$$\begin{matrix}{X}^{k} = ( {x}_{N - 1}^{k} {x}_{N - 2}^{k} … {x}_{1}^{k} {x}_{0}^{k} ) \\ {Y}^{k} = ( {y}_{N - 1}^{k} {y}_{N - 2}^{k} … {y}_{1}^{k} {y}_{0}^{k} ) \\ {Z}^{k} = ( {z}_{N - 1}^{k} {z}_{N - 2}^{k} … {z}_{1}^{k} {z}_{0}^{k} )\end{matrix}$$

A Morton code corresponding to the k^{th} point can be expressed as follows:

$${M}^{k} = ( {x}_{N - 1}^{k} {y}_{N - 1}^{k} {z}_{N - 1}^{k} , {x}_{N - 2}^{k} {y}_{N - 2}^{k} {z}_{N - 2}^{k} , {…x}_{1}^{k} {y}_{1}^{k} {z}_{1}^{k} , {x}_{0}^{k} {y}_{0}^{k} {z}_{0}^{k} )$$

Each three bits are expressed by octal numbers, mₙ^{k}=(xₙ^{k}yₙ^{k}zₙ^{k}), n=0,1, . . . , N−1, and the Morton code corresponding to the k^{th} point may be expressed as:

$${M}^{k} = ( {m}_{N - 1}^{k} {m}_{N - 2}^{k} … {m}_{1}^{k} {m}_{0}^{k} )$$

2. Order-Based Neighbor Point Selection. The Process is as Follows:

Order-based neighbor point selection includes a distance-based selection method and a spatial-relationship-and-distance-based selection method. The method is described below.

i) Distance-Based Method. Operations are as Follows:

Among the first P neighbor candidate points in the Morton order or Hilbert order, where P can be determined according to the maxNumOfNeighbours field, the Manhattan distance d=|x−xᵢ|+|y−yᵢ|+|z−zᵢ| from each neighbor candidate point (the i^{th} neighbor candidate point is expressed as (xᵢ, yᵢ, zᵢ)) to a current to-be-decoded point (x, y, z) is calculated. Based on obtaining the Manhattan distance from each neighbor candidate point to the current to-be-decoded point (x, y, z), k neighbor candidate points with the shortest Manhattan distance can be used as neighbors of the current to-be-decoded point. The maximum distance among the k points with the shortest Manhattan distance may be determined, all neighbor candidate points whose Manhattan distance is less than or equal to the maximum distance are used as neighbors of the current point, and m points with the shortest Manhattan distance are finally determined as the nearest neighbor of the current to-be-decoded point, where m and k are positive integers and m≤k.

ii) Spatial-Relationship-and-Distance-Based Selection Method. Operations are as Follows:

An initial block size is first determined, for example, an initial number N of right shift bits of a codeword corresponding to each point is determined. On this basis, N+3 is the corresponding parent block range.

The point clouds may be traversed in an ordered fashion. As shown in FIG. 1B, the nearest neighbor is searched from decoded points within the range of the parent block of block B of the current to-be-decoded point (point P) and a neighbor block that is coplanar, collinear, and copoint with the parent block (limited to the range of the first k points).

If the number of neighbor points of the current to-be-decoded point determined is insufficient, neighbor point selection may be performed according to the distance-based method in i), for example.

3. Predicted Value Calculation. The Process is as Follows:

Assuming that the reconstructed attribute value of each neighbor is (Âⱼⱼ), j=0.1 . . . k, a predicted attribute value Âᵢ of the current point is:

$$\hat{{A}_{i}} = \frac{{\sum }_{j = 1}^{k} {w}_{ij} {\hat{A}}_{ij}}{{\sum }_{j = 1}^{k} {w}_{ij}}$$

### i) Distance-Based Weighted Calculation:

The reciprocal of the Manhattan distance between the current to-be-decoded point and the neighbor point may be used as the weight, and the weighted average of the reconstructed attribute values of k neighbor points may be calculated to obtain the predicted attribute value. Assuming that the geometry coordinates of the current to-be-decoded point are (xᵢ, yᵢ, zᵢ) and the geometry coordinates of the j^{th} neighbor point are (xᵢⱼ, yᵢⱼ, z^{ij}), the weight wᵢⱼ of the j^{th} neighbor point is:

$${w}_{ij} = \frac{1}{\vert {x}_{i} - {x}_{ij} \vert + \vert {y}_{i} - {y}_{ij} \vert + \vert {z}_{i} - {z}_{ij} \vert}$$

If components in the x, y, and z directions adopt different weights, the weight wᵢⱼ of the j^{th} neighbor point may be:

$${w}_{ij} = \frac{1}{a \vert {x}_{i} - {x}_{ij} \vert + b \vert {y}_{i} - {y}_{ij} \vert + c \vert {z}_{i} - {z}_{ij} \vert}$$

### ii) Weighted Calculation Based on a Distance and Other Parameters:

The weight of each neighbor point of the current to-be-decoded point is w=1/d, and the optimized weight of the neighbor candidate point whose distance is equal to the maximum distance is wm=(1/d)*dwm, where the value of dwm is the smaller value of Qstep (an attribute quantization step) and the number of neighbor candidate points whose distance is equal to the maximum distance.

### (2) Attribute Transform:

The core of attribute transform is attribute coding that combines prediction and transform. The process is as follows:

First, the to-be-coded point cloud after color space conversion and recoloring is reordered in ascending order of Hilbert codes, and adaptive grouping and corresponding K-element transform may be used. The process is as follows:

### i) Point Cloud Grouping:

The point clouds are grouped sequentially based on the order of the space filling curve, and points with the same first L bits of the Hilbert codes are grouped into one group. When the number of points in the same group exceeds a preset limit point number, the group is subdivided. In addition, adjustment can also be made during grouping according to the number of points of the previous group.

### ii) Intra-Group Prediction:

The prediction point selection range is among the first P points of the first point in the current group, and P can be determined based on the maxNumOfNeighbours field. The P points are predicted one by one, and a unified prediction value is selected or calculated for each group. For example, the predicted value of the first point of the current group is used as the predicted value of the current group.

iii) Residual-Value-Based Transform:

K_i-element DCT for discrete cosine transform (DCT transform) is performed on the predicted attribute residual value of each group of points, where K_i=2, . . . , 8, and quantized entropy coding is performed on the transform coefficient. When K_i=1, a transform calculation may not be performed, and quantized entropy coding is directly performed on the attribute residual value. The obtained transform coefficient is quantized.

### (3) Entropy Coding:

The quantized (in a lossy case) signed predicted attribute residual coefficient or transform coefficient is binarized and processed. Entropy coding can be Variable-length coding, content adaptive binary arithmetic coding, run-length coding, or the like. Details are as follows:

### 1. Variable-Length Coding:

Codewords of different lengths are used to represent the residuals or coefficients that may be coded. The code length may be designed based on the probability of symbol occurrence. Variable-length coding may include exponential Golomb coding (exp-Golomb) and arithmetic coding.

### 2. Content Adaptive Binary Arithmetic Coding (CABAC) May Include the Following Operations:

Binarization: CABAC uses binary arithmetic coding, which means that two numbers (1 or 0) are coded. A non-binary numerical symbol, such as a conversion coefficient or a motion vector, may be binarized or converted into a binary codeword and arithmetic coding may be performed. This process is similar to converting a numerical value into a variable-length codeword. This binary codeword may be coded by an arithmetic coder before transmission.

Context model selection: The context model is a probabilistic model that is selected based on statistics of the most recent coded data symbols. This model stores the probability that each ‘bin’ is 1 or 0.

Arithmetic coding: The arithmetic coder codes each ‘bin’ according to the selected probabilistic model.

Probability update: The selected context model is updated based on the actual coding value. For example, if the value of ‘bin’ is 1, the frequency count of 1 is increased.

### 3. Run-Length Coding:

A number of consecutive points being a symbol in statistical data is recorded as the run-length. If the current symbol is zero, the run-length value is increased by 1. If the current symbol is non-zero, the run-length value is first coded, the non-zero attribute prediction residual may be coded, and the run-length value may be set to 0 to restart counting. A coding scheme, such as variable-length coding or CABAC, can be used for the residual.

Run-length coding may be divided into two types: fixed-length run-length coding and variable-length run-length coding. Fixed-length run-length coding means that the number of binary digits used in the coding run-length is fixed. Variable-length run-length coding refers to coding different ranges of run-lengths using different numbers of binary digits, and a flag bit may be added to indicate the number of binary digits used.

Some embodiments provide a point cloud processing solution. When a to-be-coded point in a point cloud is to be coded, a limit parameter of the point cloud can be set, attribute information of the to-be-coded point in the point cloud is obtained, the attribute information of the to-be-coded point is coded, and a coding process is applied based on the limit parameter. When the to-be-decoded point in the point cloud is to be decoded, a coded code stream of a to-be-decoded point in the point cloud can be obtained, the coded code stream of the to-be-decoded point is decoded, and a decoding process is applied based on the limit parameter. In some embodiments, the coding and decoding process of attribute information of each point in the point cloud may be applied based on the limit parameter of the point cloud, which may improve the coding and decoding performance of the attribute information of the point cloud.

The point cloud processing solution provided by some embodiments can also be combined with cloud computing, cloud storage, and other technologies in cloud technologies. Cloud computing is a computing model that distributes computing tasks on a resource pool including a large number of computers, enabling various application systems to obtain computing power, storage space, and information services. Cloud computing can provide powerful computing support for the coding stage of point cloud attributes and the decoding stage of point cloud attributes, which may improve the coding efficiency of point cloud attributes and improve the decoding efficiency of point cloud attributes. Cloud storage is a new concept developed based on the concept of cloud computing. A distributed cloud storage system (also referred to as a “storage system”) is a storage system that combines many different types of storage devices (storage devices are also referred to as storage nodes) in a network through application software or an application interface based on cluster application, a grid technology, a distributed storage file system, and other functions, so that the storage devices work in coordination with each other to jointly provide data storage and service access functions to the outside. Cloud storage can provide powerful storage support for the coding stage of point cloud attributes and the decoding stage of point cloud attributes, which may improve the coding efficiency of point cloud attributes and improve the decoding efficiency of point cloud attributes. In addition, the point cloud processing solution provided by some embodiments can also be combined with artificial intelligence. Some embodiments include deep learning technology in artificial intelligence. The model used in the coding and decoding process may be optimized and trained by training a data set. For example, the initial model may be trained by training a data set to obtain the context model.

A point cloud processing system capable of implementing the point cloud processing solution provided by some embodiments is introduced with reference to FIG. 2. As shown in FIG. 2, a point cloud processing system 20 may include a coding device 201 and a decoding device 202. The coding device 201 may be a terminal or a server. The decoding device 202 may be a terminal or a server. The coding device 201 and the decoding device 202 may establish a communication connection. The terminal may be a smartphone, a tablet computer, a notebook computer, a desktop computer, a smart speaker, a smartwatch, a vehicle-mounted terminal, a smart TV, or the like, but is not limited thereto. The server can be an independent physical server, or a server cluster including multiple physical servers or a distributed system, or may be a cloud server that provides cloud computing services such as cloud services, cloud databases, cloud computing, cloud functions, cloud storage, network services, cloud communications, middleware services, domain name services, security services, content delivery networks (CDN), big data, and artificial intelligence platforms.

### (1) Coding Device 201:

The coding device 201 can obtain point cloud data (for example, geometry information and attribute information of each point in the point cloud). The point cloud data can be obtained in two manners: scene capture or device generation. Scene capture of point cloud data refers to collecting real-world visual scenes through a capture device associated with the coding device 201, to obtain point cloud data. The capture device may be configured to provide point cloud data obtaining services for the coding device 201. The capture device may include, but is not limited to any one of the following: a camera device, a sensing device, and a scanning device. The camera device can include cameras, stereo cameras, light field cameras, or the like, the sensing device can include laser devices, radar devices, or the like, and the scanning device can include three-dimensional laser scanning devices. The capture device associated with the coding device 201 may be a hardware component provided in the coding device 201. For example, the capture device may be a camera, a sensor, or the like of the terminal. The capture device associated with the coding device may also be a hardware device connected to the coding device 201, such as a camera connected to the server. Device generation of point cloud data refers to generating point cloud data by the coding device 201 based on virtual objects (for example, virtual three-dimensional objects and virtual three-dimensional scenes obtained through three-dimensional modeling).

The coding device 201 can code geometry information of each point in the point cloud to obtain a geometry bit stream (including geometry coding information of each point in the point cloud), and can code attribute information of each point in the point cloud to obtain an attribute bit stream (including attribute coding information of each point in the point cloud). In particular, when the coding device 201 codes the attribute information of the to-be-coded point in the point cloud, the limit parameter of the point cloud can be set. Based on the limit parameter of the point cloud, obtained attribute information of the to-be-coded point can be coded, thereby controlling the coding process. After obtaining the compressed code stream of the point cloud, the coding device 201 transmits the compressed code stream (for example, the attribute bit stream and the geometry bit stream) to the decoding device 202.

### (2) Decoding Device 202:

Based on receiving the compressed code stream (for example, the attribute bit stream and the geometry bit stream) transmitted by the coding device 201, the decoding device 202 can decode the geometry bit stream to reconstruct geometry information of each point in the point cloud, and can decode the attribute bit stream to obtain attribute information of each point in the point cloud. Based on the decoding device 202 decoding the to-be-decoded point in the point cloud, the limit parameter of the point cloud can be obtained, and the obtained coded code stream of the to-be-decoded point is decoded based on the limit parameter of the point cloud, thereby controlling the decoding process. Based on obtaining the reconstructed geometry information and the reconstructed attribute information of each point in the point cloud, the decoding device 202 establishes a one-to-one correspondence between the reconstructed geometry information and the reconstructed attribute information of each point in the point cloud, to reconstruct the point cloud.

In some embodiments, based on the to-be-coded point in the point cloud to be coded, the limit parameter of the point cloud can be set, the attribute information of the to-be-coded point in the point cloud is obtained, the attribute information of the to-be-coded point is coded, and the coding process is applied based on the limit parameter. When the to-be-decoded point in the point cloud is to be decoded, the coded code stream of the to-be-decoded point in the point cloud can be obtained, the coded code stream of the to-be-decoded point is decoded, and the decoding process is applied based on the limit parameter. In some embodiments, the coding and decoding process of attribute information of each point in the point cloud may applied based on the limit parameter of the point cloud, which may improve the coding and decoding performance of the attribute information of the point cloud. The point cloud processing system described in some embodiments is for more clearly describing the technical solutions in some embodiments, and does not constitute a limitation on the technical solutions provided in some embodiments. A person of ordinary skill may learn that with evolution of a network architecture and appearance of a new service scenario, the technical solutions provided in some embodiments are also applicable to a similar technical problem.

The point cloud processing solution provided in some embodiments will be described with respect to the accompanying drawings.

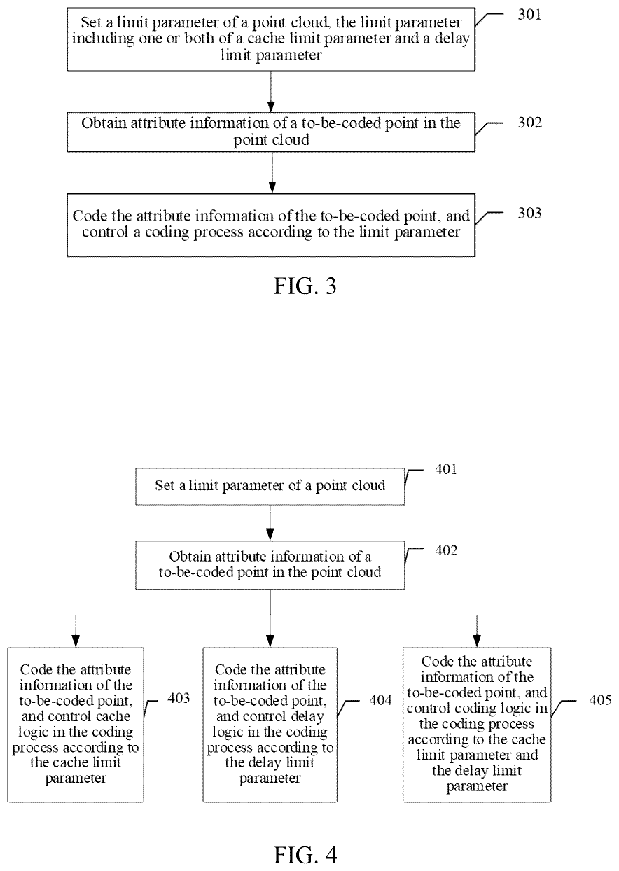

FIG. 3 shows a point cloud processing method according to some embodiments. The point cloud processing method can be executed by a computer device. The computer device may be the coding device 201 in the point cloud processing system 20 shown in FIG. 2. As shown in FIG. 3, the point cloud processing method may include the following operation 301 to operation 303:

301: Set a limit parameter of a point cloud, the limit parameter including one or both of a cache limit parameter and a delay limit parameter.

The limit parameter may be configured for setting a trigger condition for coding attribute information of a to-be-coded point in the point cloud. The limit parameter may include at least one of a cache limit parameter and a delay limit parameter. The cache limit parameter is used to control cache logic in the coding process. For example, based on a number of intermediate coefficients (for example, residual and transform coefficients corresponding to the attribute information of the to-be-coded point) corresponding to the attribute information of the to-be-coded point in a cache queue meeting the trigger condition (for example, the number of intermediate coefficients corresponding to the attribute information of the to-be-coded point in the cache queue reaches a cache threshold indicated by the cache parameter) set based on the cache limit parameter, the computer device (the coding device) codes the intermediate coefficient corresponding to the attribute information of the to-be-coded point in the cache queue. Similarly, the delay limit parameter is used to control coding logic in the coding process. For example, based on a delay amount of the intermediate coefficient corresponding to the attribute information of the to-be-coded point meeting a trigger condition (for example, the delay amount of the intermediate coefficient corresponding to the attribute information of the to-be-coded point reaches a delay threshold indicated by the delay parameter) set based on the delay limit parameter, the computer device (the coding device) codes the intermediate coefficient corresponding to the attribute information of the to-be-coded point. The delay amount is used to indicate the number of intermediate coefficients corresponding to the attribute information of the current to-be-coded point.

A setting manner of the limit parameter includes any one or more of the following: setting the limit parameter to a default value; setting the limit parameter to a fixed value, and encapsulating the set limit parameter into a coded code stream formed by coding; setting the limit parameter to a variable value, and encapsulating the set limit parameter into a coded code stream formed by coding, for example, setting the limit parameter to a in a coded code stream 1, setting the limit parameter to b in a coded code stream 2, and setting the limit parameter to c in a coded code stream 3, where a, b, and c are different from each other; and dynamically adjusting the value of the limit parameter during the coding process, and encapsulating the dynamically adjusted limit parameter into a coded code stream formed by coding. Taking the coding as run-length coding as an example, the computer device can count lengths of the first Q runs, dynamically adjust the value of the limit parameter according to the lengths of the first Q runs, and encapsulate the dynamically adjusted limit parameter into the coded code stream formed by the coding. If the limit parameter is not set, the limit parameter is a default value. Various setting manners are used to limit the limit parameter, and the coding delay may be flexibly controlled, which may determine the coding performance of attribute information of the point cloud in various scenarios.

302: Obtain attribute information of a to-be-coded point in the point cloud.

The attribute information of the to-be-coded point may include at least one of the following: color information, material information, and laser reflection intensity information (which may be also referred to as reflectivity). Usually, each point in the point cloud has the same amount of attribute information. For example, each point in the point cloud can have two types of attribute information: color information and laser reflection intensity information. Each point in the point cloud may have three types of attribute information: color information, material information, and laser reflection intensity information. The attribute information of the to-be-coded point can be generated based on data collected by a collection device (for example, cameras and 3D laser scanners), or directly generated by a computer based on virtual three-dimensional objects and scenes.

303: Code the attribute information of the to-be-coded point, and control a coding process based on the limit parameter.

A manner of coding the attribute information of the to-be-coded point includes: The attribute information of the to-be-coded point is coded in unit of a number of points, and the attribute information of the to-be-coded point is coded in unit of a number of groups. Coding in unit of a number of points refers to coding a point in the point cloud as a coding unit or a coding block. Coding in unit of a number of groups refers to coding a group (a group can include at least one point in the point cloud) in the point cloud as a coding unit or a coding block.

the computer device coding the attribute information of the to-be-coded point in unit of a number of points may include: converting the attribute information of the to-be-coded point, to obtain an intermediate coefficient of the to-be-coded point; where the converting the attribute information of the to-be-coded point can be: predicting the attribute information of the to-be-coded point, to obtain the residual between the prediction information of the to-be-coded point and the attribute information of the to-be-coded point; or can be: based on obtaining the residual, transforming the residual to obtain a transform coefficient. For example, the intermediate coefficient of the to-be-coded point obtained by converting the attribute information of the to-be-coded point can be a residual coefficient or a transform coefficient.

Based on obtaining the intermediate coefficient of the to-be-coded point, the computer device can write the intermediate coefficient of the to-be-coded point in the cache, and read the intermediate coefficient of the to-be-coded point from the cache for coding. For example, the computer device can write the intermediate coefficient of the to-be-coded point in a cache queue set based on the cache limit parameter. When the cache queue is full (for example, intermediate coefficients of to-be-coded points collectively stored in the cache queue reach a cache threshold), the computer device reads the intermediate coefficient of the to-be-coded point from the cache queue for coding. The computer device can also obtain a delay amount of the intermediate coefficient of the current to-be-coded point. If the delay amount of the intermediate coefficient of the current to-be-coded point reaches a delay threshold, the computer device codes the intermediate coefficient of the current to-be-coded point. The above descriptions of point cloud coding may be considered for implementation of the computer device coding the intermediate coefficient of the to-be-coded point. In some embodiments, the attribute information of the to-be-coded point is converted in unit of a number of points, and the obtained intermediate coefficient is written in the cache, so that the intermediate coefficient is read from the cache for coding, which may control the delay of the point cloud coding process, avoid an excessively long waiting time for point cloud coding, and help improve the coding and decoding performance of attribute information of the point cloud.

In some embodiments, the computer device coding the attribute information of the to-be-coded point in unit of a number of groups may include grouping attribute information of to-be-coded points, to obtain multiple point cloud groups. The basis for grouping can be set according to actual coding requirements. In some embodiments, the computer device can group the attribute information of the to-be-coded points based on the order of a space filling curve. For example, the computer device can group the attribute information of the to-be-coded points with the same first L bits of Hilbert codes into a group. Based on obtaining multiple point cloud groups, the computer device can convert the attribute information of the to-be-coded points in the point cloud groups to obtain converted point cloud groups. Converting the attribute information of the to-be-coded point in the point cloud group is described above. The converted point cloud group includes intermediate coefficient of the to-be-coded point, and the intermediate coefficient includes a residual coefficient or a transform coefficient.

Based on obtaining the converted point cloud group, the computer device can write the converted point cloud group in the cache, and sequentially read the intermediate coefficients of the to-be-coded points in the converted point cloud group from the cache for coding. For example, the computer device can write the converted point cloud group in a cache queue set based on the cache limit parameter. When the cache queue is full (for example, the converted point cloud group stored in the cache queue reaches a cache threshold), the computer device reads the converted point cloud group from the cache queue for coding. The computer device may also obtain a delay amount of the current converted point cloud group. If the delay amount of the current converted point cloud group reaches a delay threshold, the computer device codes the current converted point cloud group. The above descriptions of point cloud coding may be considered for implementation of the computer device coding the converted point cloud group. In some embodiments, the attribute information of the to-be-coded point is converted in unit of a number of groups, and the obtained intermediate coefficient is written in the cache, so that the intermediate coefficient is read from the cache for coding, which may control the delay of the point cloud coding process, avoid an excessively long waiting time for point cloud coding, and help improve the coding and decoding performance of attribute information of the point cloud.

In some embodiments, based on the to-be-coded point in the point cloud to be coded, the limit parameter of the point cloud can be set, the attribute information of the to-be-coded point in the point cloud is obtained, the attribute information of the to-be-coded point is coded, and the coding process is applied based on the limit parameter. In some embodiments, the coding process of the attribute information of the to-be-coded point is applied based on setting the limit parameter of the point cloud, which may improve the coding performance of the attribute information of the point cloud.

FIG. 4 illustrates a point cloud processing method according to some embodiments. The point cloud processing method can be executed by a computer device. The computer device may be the coding device 201 in the point cloud processing system 20 shown in FIG. 2. As shown in FIG. 4, the point cloud processing method may include the following operation 401 to operation 405:

401: Set a limit parameter of a point cloud.

The limit parameter includes one or both of a cache limit parameter (coeffLengthControl) and a delay limit parameter (maxNumofCoeff). The limit parameter may be configured for determining a coding limit point number threshold.

Based on the limit parameter including one type of parameter, a unit of the limit parameter may include any one of the following: a unit of a number of points and a unit of a number of groups. Limiting in unit of a number of points means limiting a number of to-be-coded points based on coding in unit of a number of points. Limiting in unit of a number of groups means limiting a number of to-be-coded groups based on coding in unit of a number of groups. When the limit parameter is a cache limit parameter, the coding limit point number threshold is a cache limit point number threshold. The unit of the cache limit parameter can be a number of points or a number of groups. Similarly, based on the limit parameter being a delay limit parameter, the coding limit point number threshold is a delay limit point number threshold. The unit of the delay limit parameter can be a number of points or a number of groups. Details are as follows:

If the limit parameter is in unit of a number of points and the value of the limit parameter is X1, the coding limit point number threshold is an actual total number of intermediate coefficients of X1 to-be-coded points. For example, assuming that the limit parameter is a cache limit parameter in unit of a number of points and the value of the cache limit parameter is 1024, the coding limit point number threshold is the actual total number of intermediate coefficients of 1024 to-be-coded points. For another example, assuming that the limit parameter is a delay limit parameter in unit of a number of points and the value of the delay limit parameter is 2048, the coding limit point number threshold is the actual total number of intermediate coefficients of 2048 to-be-coded points.

If the cache limit parameter is in unit of a number of groups and the value of the limit parameter is X2, the coding limit point number threshold is an actual total number of intermediate coefficients of to-be-coded points in X2 point cloud groups. For example, assuming that the limit parameter is a cache limit parameter in unit of a number of groups and the value of the cache limit parameter is 64, the coding limit point number threshold is the actual total number of intermediate coefficients of to-be-coded points of 64 point cloud groups. Assuming that the limit parameter is a delay limit parameter in unit of a number of groups and the value of the delay limit parameter is 128, the coding limit point number threshold is the actual total number of intermediate coefficients of to-be-coded points of 128 point cloud groups.

If the limit parameter is in unit of a number of groups, the value of the limit parameter is X3, and a number of points in each point cloud group is limited to X4, the coding limit point number threshold is a total number of intermediate coefficients of to-be-coded points in X3 point cloud groups, where the total number does not exceed the value of X3*X4. For example, assuming that the limit parameter is a cache limit parameter in unit of a number of groups and the value of the cache limit parameter is 64, and the number of points in each point cloud group is limited to 4, the coding limit point number threshold is the actual total number of intermediate coefficients of to-be-coded points of 64 point cloud groups. The total number does not exceed 64*4=256. Assuming that the limit parameter is a delay limit parameter in unit of a number of groups, the value of the delay limit parameter is 128, and the number of points in each point cloud group is limited to 4, the coding limit point number threshold is the actual total number of intermediate coefficients of to-be-coded points of 128 point cloud groups. The total number does not exceed 128*4=512. In some embodiments, for different types and different units of limit parameters, the number of to-be-coded points that use delay during coding is determined accordingly, so that accurate delay can be performed on the coding process in various limit parameter setting scenarios, to determine coding and decoding performance of the attribute information of the point cloud.

Based on the limit parameter including two types of parameters, a unit of the limit parameter may include any one or more of the following: unit of a number of points, unit of a number of groups, and unit of a multiple relationship. A limit parameter 1 being in unit of a multiple refers to: based on a limit parameter 2 limiting the number of to-be-coded points in unit of a number of points, the limit parameter 1 limits the number of to-be-coded points in unit of a number of points, and the number of to-be-coded points limited by the limit parameter 1 is a multiple of the number of to-be-coded points limited by the limit parameter 2. If the cache limit parameter is in unit of a multiple relationship and the value of the cache limit parameter is Y1, a cache limit point number threshold may be Y1 times a delay limit point number threshold. If the delay limit parameter is in unit of a multiple relationship and the value of the delay limit parameter is Y2, the delay limit point number threshold may be Y2 times the cache limit point number threshold. For example, assuming that the delay limit parameter (the limit parameter 1) is in unit of a multiple and is 2, based on the cache limit parameter (the limit parameter 2) being in unit of a number of points and the value of the cache limit parameter is 1024, the delay limit parameter is in unit of a number of points and the delay limit parameter is 1024*2=2048.

When the limit parameter 2 limits the number of to-be-coded groups in unit of a number of groups, the limit parameter 1 limits the number of to-be-coded groups in unit of a number of groups, and the number of to-be-coded groups limited by the limit parameter 1 is a multiple of the number of to-be-coded groups limited by the limit parameter 2. If the cache limit parameter is in unit of a multiple relationship and the value of the cache limit parameter is Y1, the cache limit point number threshold may be Y1 times the delay limit point number threshold. If the delay limit parameter is in unit of a multiple relationship and the value of the delay limit parameter is Y2, the delay limit point number threshold may be Y2 times the cache limit point number threshold. For example, assuming that the delay limit parameter (the limit parameter 1) is in unit of a multiple and is 2, based on the cache limit parameter (the limit parameter 2) being in unit of a number of groups and the value of the cache limit parameter is 64, the delay limit parameter is in unit of a number of groups and the delay limit parameter is 64*2=128. In some embodiments, the cache limit parameter and the delay limit parameter are combined to determine the number of to-be-coded points that use delay during coding, and accurate delay can be performed on the coding process in the limit parameter setting scenario including the two parameters: the cache limit parameter and the delay limit parameter, to determine the coding and decoding performance of the attribute information of the point cloud.

It can be known from the foregoing that a combination manner includes: the limit parameter 1 and the limit parameter 2 are both in unit of a number of points or in unit of a number of groups; the limit parameter 1 is in unit of a number of points, and the limit parameter 2 is in unit of a number of groups, or the limit parameter 2 is in unit of a multiple; and the limit parameter 1 is in unit of a number of groups, and the limit parameter 2 is in unit of a number of points, or the limit parameter 2 is in unit of a multiple. The limit parameter 1 may be any one of the cache limit parameter and the delay limit parameter, and the limit parameter 2 may be the other one of the cache limit parameter and the delay limit parameter. The limit parameter includes the number of parameter types, and the corresponding units are flexibly set, so that the coding delay can be flexibly controlled, which may determine the coding performance of the attribute information of the point cloud in various scenarios.

402: Obtain attribute information of a to-be-coded point in the point cloud.

In some embodiments, the details of operation 302 shown in FIG. 3 may be applied to operation 402.

When the limit parameter is a cache limit parameter, operation 403 is performed. When the limit parameter is a delay limit parameter, operation 404 is performed. When the limit parameter includes a cache limit parameter and a delay limit parameter, operation 405 is performed.

403: Code the attribute information of the to-be-coded point, and control cache logic in a coding process according to the cache limit parameter.

The cache limit parameter may be used to limit the number of to-be-coded points that are allowed to be written in the cache, and each to-be-coded point may include one or more intermediate coefficients. The cache limit parameter is used to determine the number of to-be-coded points that are allowed to be written in the cache, so that the coding process of attribute information of the to-be-coded point may be controlled, which can avoid an excessively long waiting time for point cloud coding, which may improve the coding performance of the attribute information of the point cloud. The computer device may determine a cache limit point number threshold according to the cache limit parameter. The cache limit point number threshold is used to limit a number threshold of to-be-coded points allowed to be written in the cache. Each time the number of to-be-coded points written in the cache reaches the cache limit point number threshold, the computer device reads the intermediate coefficient of the to-be-coded point from the cache for coding. The cache limit point number threshold determined based on the cache limit parameter is used to control the number of to-be-coded points that are allowed to be written in the cache. When the number of to-be-coded points that are allowed to be written in the cache reaches the cache limit point number threshold, coding is triggered, which can avoid an excessively long waiting time for point cloud coding, which may improve the coding performance of the attribute information of the point cloud.

In some embodiments, the coding scheme is based on a number of groups, for example, a group in the point cloud is coded as a coding unit or a coding block. Based on reading the intermediate coefficient of the to-be-coded point from the cache for coding based on the number of to-be-coded points written in the cache reaching the cache limit point number threshold, the computer device counts the total number of to-be-coded points included in each point cloud group in the cache. When the number of groups stored in the cache is M, and the total number of to-be-coded points included in the M point cloud groups reaches the cache limit point number threshold, the computer device reads the intermediate coefficient of the to-be-coded point included in the M point cloud groups from the cache for coding. Further, the computer device clears the cache and continues to write the intermediate coefficient of the to-be-coded point in the cache. In some embodiments, based on coding in unit of a number of groups, the total number of to-be-coded points in all point cloud groups is controlled based on the cache limit point number threshold, to control delay on the coding process of the attribute information of the to-be-coded point, which helps improve coding performance of the attribute information of the point cloud.

In some embodiments, the coding scheme is based on a number of groups, for example, a group in the point cloud is coded as a coding unit or a coding block. Based on reading the intermediate coefficient of the to-be-coded point from the cache for coding based on the number of to-be-coded points written in the cache reaching the cache limit point number threshold, the computer device counts the number M of point cloud groups included in the cache, and calculates, based on M and the point number limit threshold of the point cloud group, the total number of to-be-coded points included in the cache. For example, assuming M=64 and the point number limit threshold is 8, the total number of to-be-coded points included in the cache is 64*8=512. If the total number of to-be-coded points included in the cache reaches the cache limit point number threshold, the computer device reads the intermediate coefficient of the to-be-coded point included in the M point cloud groups from the cache for coding. Further, the computer device clears the cache and continues to write the intermediate coefficient of the to-be-coded point in the cache. In some embodiments, based on coding in unit of a number of groups, the number of to-be-coded points in each point cloud group is controlled based on the point number limit threshold, and the total number of to-be-coded points in all point cloud groups is controlled based on the cache limit point number threshold, to control delay on the coding process of the attribute information of the to-be-coded point, which helps improve coding performance of the attribute information of the point cloud.

The coding scheme may be in unit of a number of groups, for example, a group (a group may include at least one point in the point cloud) in the point cloud is coded as a coding unit or a coding block. The computer device determines, according to the cache limit parameter, a number threshold of point cloud groups allowed to be written in the cache. Each time the number of point cloud groups written in the cache reaches the group number threshold, the computer device reads, from the cache for coding, the intermediate coefficient of the to-be-coded point included in the point cloud groups written in the cache. For example, if the value of the cache limit parameter is 64, the computer device determines that the number of point cloud groups allowed to be written in the cache is 64 according to the cache limit parameter. Each time the number of point cloud groups written in the cache is 64, the computer device reads the intermediate coefficients of the to-be-coded points included in the 64 point cloud groups from the cache for coding. In some embodiments, based on coding in unit of a number of groups, delay is applied, based on the group number threshold, on the number of point cloud groups allowed to be written in the cache, which helps improve the coding performance of the attribute information of the point cloud.

Further, the computer device can arrange, according to a preset arrangement manner, the point cloud groups written in the cache, and encapsulate the preset arrangement manner into the coded code stream formed by coding. According to some embodiments, the computer device encapsulating the arrangement manner of the intermediate coefficients of the point cloud group in the cache into the coded code stream formed by coding is: each arrangement manner corresponds to an index value, and the computer device writes an index value corresponding to an arrangement manner of the intermediate coefficients of the point cloud group in the cache in the coded code stream. By writing the index value corresponding to the arrangement manner of the intermediate coefficients of the point cloud group in the coded code stream, it is convenient to decode the coded code stream based on the index value, which helps improve the decoding processing efficiency of the coded code stream. The computer device can also arrange, according to a preset arrangement manner, the point cloud groups written in the cache, and directly send the preset arrangement manner to the decoding device. The computing device may also arrange, according to a default arrangement manner, the point cloud groups written in the cache. When arranging, according to the default arrangement manner, the point cloud groups written in the cache, the computer device may not inform the decoding device of the arrangement manner. The preset arrangement manner includes any one of the following: a fixed arrangement manner and a dynamic arrangement manner. The fixed arrangement manner means that an arrangement manner of intermediate coefficients of the point cloud group cached each time is the same (for example, according to similarity, or according to the number of to-be-coded points included in the group), and the dynamic arrangement manner means that an arrangement manner of intermediate coefficients of the point cloud group in the cache changes. For example, the arrangement manner of the intermediate coefficients of the point cloud group cached for the first time is the same as the arrangement manner of the intermediate coefficients of the point cloud group cached for the second time, and the arrangement manner of the intermediate coefficients of the point cloud group cached for the third time is different. In some embodiments, the point cloud groups written in the cache are arranged in either a fixed arrangement manner or a dynamic arrangement manner, which may facilitate orderly coding of the point cloud and help improve the decoding processing efficiency of the coded code stream.

In some embodiments, the coding includes run-length coding, and the computer device determines, according to the cache limit parameter, a cache limit point number threshold of to-be-coded points that are allowed to be written in the cache, where the cache limit point number threshold is used to limit a number threshold of to-be-coded points that are allowed to be written in the cache during the coding process. For a manner of determining the cache limit point number threshold, refer to the manner of determining the coding limit point number threshold in operation 401. The computer device sets, during run-length coding, a run-length used to count consecutive symbols. At the beginning, the computer device sets the run-length to an initial value, and in a process of sequentially reading the intermediate coefficients of the to-be-coded points from the cache, if an intermediate coefficient whose value is a symbol is read, increases a count value of the run-length by one step; if a number of to-be-coded points that are read is equal to the cache limit point number threshold, codes the current run-length, or codes the cache limit point number threshold and an intermediate coefficient of a to-be-coded point whose value is a symbol, and sets the run-length to the initial value for recount; and if an intermediate coefficient of a to-be-coded point whose value is a non-specific symbol is read, codes the current run-length and the intermediate coefficient of the non-specific symbol, and resets the run-length to the initial value for recount.

For example, it is assumed that the cache limit parameter is in unit of a number of points and is 1024 (for example, the cache limit point number is 1024). If the computer device uses run-length coding to code the residual of the attribute information of the to-be-coded point, the computer device counts the number of consecutive points being a symbol (for example, 0) in the residual of the attribute information of the to-be-coded points, and records the number as a run-length. If the residual of the attribute information of the current to-be-coded point is a symbol, the value of the run-length is increased by 1. Each time the number of to-be-coded points in the cache reaches 1024, the computer device codes the value of the run-length and the residual of the attribute information of the current to-be-coded point, sets the run-length to the initial value (for example, 0), and recounts the run-length. If the residual of the attribute information of the current to-be-coded point is a non-specific symbol (for example, non-0), the computer device codes the current value of the run-length and the residual of the attribute information of the current to-be-coded point, sets the run-length to the initial value (for example, 0), and recounts the run-length.

In some embodiments, based on the intermediate coefficients of the to-be-coded points being sequentially read from the cache, the coding is performed on the intermediate coefficients of different symbols through the run-length, so that the intermediate coefficients of different symbols are coded separately, which may determine the coding performance of the attribute information of the point cloud.

404: Code the attribute information of the to-be-coded point, and control delay logic in the coding process according to the delay limit parameter.

The delay limit parameter is used to perform delay control on the number of to-be-coded points, so that the coding process of attribute information of the to-be-coded point may be controlled, which can avoid an excessively long waiting time for point cloud coding, which may improve the coding performance of the attribute information of the point cloud. The coding scheme used by the computer device to code the attribute information of the to-be-coded point is a coding scheme that uses statistics collection on the previous points. For example, the coding scheme used by the computer device to code the attribute information of the to-be-coded point may be run-length coding. The following uses run-length coding as an example of the coding scheme for description:

According to some embodiments, the computer device determines a delay limit point number threshold according to the delay limit parameter, where the delay limit point number threshold is used to limit a number threshold of to-be-coded points that are allowed to be delayed during coding. For a manner of determining the delay limit point number threshold, refer to the manner of determining the coding limit point number threshold in operation 401. In the process of run-length coding, the run-length used to count consecutive symbols is set, and the run-length is set to an initial value (for example, 0). In the process of sequentially reading the intermediate coefficients of the to-be-coded points from the cache, if the computer device reads the intermediate coefficient whose value is a symbol, the computer device increases the count value of the run-length by one step, and obtains the count value of the run-length. If the count value of the run-length reaches the delay limit point number threshold, the computer device performs parameter coding processing and resets the run-length to the initial value for recount. The parameter coding processing by the computer device refers to: the computer device codes the current run-length; or the computer device codes a limit identifier, where the limit identifier may be configured for setting the run-length to a preset value (for example, the preset value may be a delay limit point number threshold); or the computer device codes the delay limit point number threshold and the intermediate coefficient of the to-be-coded point whose value is a symbol. If reading an intermediate coefficient of a to-be-coded point whose value is a non-specific symbol, the computer device codes the current run-length and the intermediate coefficient of the non-specific symbol, and resets the run-length to the initial value for recount.

For example, it is assumed that the current run-length is 63, the symbol is 0, and the delay limit point number threshold is 64. If the computer device reads that the value of the intermediate coefficient of the to-be-coded point is 0, the current run-length is 63+1=64. The computer device codes the current run-length (64), or the computer device codes the limit identifier, or the computer device codes the delay limit point number threshold (64) and the intermediate coefficient of the to-be-coded point whose value is a symbol, and resets the run-length to the initial value for recount. If the computer device reads that the value of the intermediate coefficient of the to-be-coded point is 1 (non-0), the computer device codes the current run-length (63) and the intermediate coefficient of the to-be-coded point with a value of 1, and resets the run-length to the initial value for recount.

In some embodiments, during the process of controlling the delay logic in the coding process according to the delay limit parameter, based on the intermediate coefficients of the to-be-coded points being read sequentially from the cache, the coding is performed on the intermediate coefficients of different symbols through the run-length, based on the count value of the run-length reaching the delay limit point number threshold, the parameter coding processing is performed, and based on the intermediate coefficient of a non-specific symbol being read, the coding processing is performed, so that the intermediate coefficients of different symbols are separately coded, which may determine coding performance of the attribute information of the point cloud.

According to some embodiments, the computer device determines a delay limit point number threshold according to the delay limit parameter, where the delay limit point number threshold is used to limit a number threshold of to-be-coded points that are allowed to be delayed during coding. For a manner of determining the delay limit point number threshold, refer to the manner of determining the coding limit point number threshold in operation 401. In the process of run-length coding, the run-length used to count consecutive symbols is set, and the run-length is set to an initial value (for example, 0). In the process of sequentially reading the intermediate coefficients of the to-be-coded points from the cache, if the intermediate coefficient whose value is a symbol is read, the computer device increases the count value of the run-length by one step. If a number of to-be-coded points reaches the delay limit point number threshold, the computer device codes the current run-length, or codes the delay limit point number threshold and an intermediate coefficient of a to-be-coded point whose value is a symbol, and resets the run-length to the initial value for recount. If an intermediate coefficient of a to-be-coded point whose value is a non-specific symbol is read, the computer device codes the current run-length and the intermediate coefficient of the non-specific symbol, and resets the run-length to the initial value for recount.

For example, it is assumed that the number of intermediate coefficients for current delay is 58, the symbol is 0, and the number threshold of to-be-coded points that are allowed to be delayed is 64. If the computer device reads that the value of the intermediate coefficient of the to-be-coded point is 0, the current run-length is 58+1=59, and the computer device continues to read the next intermediate coefficient. If the computer device reads that the value of the intermediate coefficient of the to-be-coded point is 1 (non-0), the computer device codes the current run-length (59) and the intermediate coefficient of the to-be-coded point with a value of 1, and resets the run-length to the initial value for recount.

In some embodiments, during the process of controlling the delay logic in the coding process according to the delay limit parameter, based on the intermediate coefficients of the to-be-coded points being read sequentially from the cache, the coding is performed on the intermediate coefficients of different symbols through the run-length, based on the number of to-be-coded points reaching the delay limit point number threshold, the parameter coding processing is performed, and based on the intermediate coefficients of non-specific symbols being read, the coding processing is performed, so that the intermediate coefficients of different symbols are separately coded, which may determine coding performance of the attribute information of the point cloud.

In some embodiments, the run-length in the run-length coding is less than or equal to the delay limit point number threshold. The computer device may set the number of bits of the run-length according to the delay limit point number threshold, such that the run-length does not exceed the delay limit point number threshold, and such that the coding can be performed on the intermediate coefficients of different symbols through the run-length, which may determine coding performance of the attribute information of the point cloud.

For example, it is assumed that the delay limit parameter is in unit of a number of points and is 1024 (for example, the delay limit point number is 1024). If the computer device uses run-length coding to code the residual of the attribute information of the to-be-coded point, the computer device counts the number of consecutive points being a symbol (for example, 0) in the residual of the attribute information of the to-be-coded points, and records the number as a run-length. If the residual of the attribute information of the current to-be-coded point is a symbol, the value of the run-length is increased by 1. Each time the value of the run-length reaches 1024, the computer device codes the value of the run-length and the residual of the attribute information of the current to-be-coded point, sets the run-length to the initial value (for example, 0), and recounts the run-length. If the residual of the attribute information of the current to-be-coded point is a non-specific symbol (for example, non-0), the computer device codes the current value of the run-length and the residual of the attribute information of the current to-be-coded point, sets the run-length to an initial value (for example, 0), and recounts the run-length.

405: Code the attribute information of the to-be-coded point, and control coding logic in the coding process according to the cache limit parameter and the delay limit parameter.

The cache limit parameter and the delay limit parameter are used to perform delay control on the number of to-be-coded points, so that the coding process of the attribute information of the to-be-coded point may be controlled, which can avoid an excessively long waiting time for point cloud coding, which may improve the coding performance of the attribute information of the point cloud. According to some embodiments, the cache limit parameter and the delay limit parameter are independent of each other. Taking the intermediate coefficient of the attribute information of the to-be-coded point as the transform coefficient as an example, the computer device first controls the cache logic in the coding process according to the cache limit parameter. According to some embodiments, refer to the descriptions of operation 403. If coding is performed in unit of a group, based on caching the intermediate coefficients of the point cloud group, the computer device can arrange the intermediate coefficients of the point cloud group and write the arrangement manner in the coded code stream; or directly specify the arrangement manner to the decoding device. The computing device clears the cache and repeats the operations until the intermediate coefficients of all point cloud groups are coded. During the coding process, the computer device determines the run-length during run-length coding according to the delay limit parameter, and controls the coding logic in the coding process based on the run-length. According to some embodiments, refer to the descriptions of operation 404.

For example, it is assumed that the cache limit parameter and the delay limit parameter are both set in unit of a number of points, the cache limit parameter is 1024, the delay limit parameter is 2048, and coding is performed in unit of a group. The computer device counts the number of to-be-coded points included in each to-be-coded point cloud group in the cache, and determines the number M of groups based on the cache limit parameter and the number of to-be-coded points included in each to-be-coded point cloud group in the cache. M is a positive integer, the total number of to-be-coded points included in the M to-be-coded point cloud groups is less than or equal to 1024, and the total number of to-be-coded points included in the M+1 to-be-coded point cloud groups is greater than 1024. The computer device arranges the transform coefficients in the M to-be-coded point cloud groups one by one (for example, in a fixed arrangement manner, a random arrangement manner, or a specified arrangement manner). Based on obtaining the transform coefficients in the M to-be-coded point cloud groups, the computer device clears the current cache and restarts caching the transform coefficients of the to-be-coded groups, until the transform coefficients in all the point cloud groups are coded. According to some embodiments, the transform coefficient of each point cloud group includes one first transform coefficient DC and at least one second transform coefficient {AC}. The arrangement manner of the transform coefficients is limited by the computer device (the coding device). For example, for the transform coefficients of points of an even number of cache limit parameters, or the number of point cloud groups in the cache is an even number, arrangement is [DC1, . . . , DCM, {AC1}, . . . , {ACM}]. For transform coefficients of points of an odd number of cache limit parameters, or the number of point cloud groups in the cache is an odd number, arrangement is [{AC1}, . . . , {ACM}, DC1, . . . , DCM]. During the coding process, the computer device can use run-length coding to code the residual of the attribute information of the to-be-coded point, count the number of consecutive points being a symbol in the residual of the attribute information of the to-be-coded point, and record the number as the run-length. If the symbol of the residual of the attribute information of the current to-be-coded point is a value (for example, 0), the value of the run-length is increased by 1. Each time the run-length reaches the delay limit point number indicated by the delay limit parameter, the value of the run-length and the residual of the attribute information of the current to-be-coded point are coded, the run-length is set to 0, and recount is performed. If the symbol of the residual of the attribute information of the current to-be-coded point is a non-specific value (for example, non-0), the computer device first codes the value of the run-length, codes the residual of the attribute information of the current to-be-coded point, and sets the run-length to 0 and recounts.

According to some embodiments, the cache limit parameter and the delay limit parameter are correlated with each other. For example, the cache limit parameter is determined based on the delay limit parameter, or the delay limit parameter is determined based on the cache limit parameter. Taking the intermediate coefficient of the attribute information of the to-be-coded point as the transform coefficient as an example, based on determining the cache limit parameter and the delay limit parameter based on the correlation, the computer device controls the cache logic in the coding process according to the cache limit parameter. According to some embodiments, refer to the descriptions of operation 403. If coding is performed in unit of a group, based on caching the intermediate coefficients of the point cloud group, the computer device can arrange the intermediate coefficients of the point cloud group and write the arrangement manner in the coded code stream; or directly specify the arrangement manner to the decoding device. The computing device clears the cache and repeats the operations until the intermediate coefficients of all point cloud groups are coded. During the coding process, the computer device determines the run-length during run-length coding according to the delay limit parameter, and controls the coding logic in the coding process based on the run-length. According to some embodiments, refer to the descriptions of operation 404.

For example, it is assumed that the delay limit parameter is in unit of a multiple and is 2, and the cache limit parameter is in unit of a number of groups and is 64. The cache limit point number determined based on the cache limit parameter is the total number of to-be-coded points in the 64 point cloud groups, and the delay limit point number determined based on the delay limit parameter is the total number of to-be-coded points in the 64*2=128 point cloud groups. For another example, assuming that the cache limit parameter is in unit of a number of groups and is 64, and there are k second transform coefficients of the first point cloud group among the 64 point cloud groups, the delay limit parameter is in unit of a number of points and is 64+k, to facilitate real-time decoding of the first point cloud group. If coding is performed in unit of a group, the computer equipment counts the number of to-be-coded points included in the 64 point cloud groups, and arranges the transform coefficients in the 64 to-be-coded point cloud groups one by one (for example, in a fixed arrangement manner, a random arrangement manner, or a specified arrangement manner). Based on obtaining the transform coefficients in the 64 to-be-coded point cloud groups, the computer device clears the current cache and restarts caching the transform coefficients of the to-be-coded groups, until the transform coefficients in all the point cloud groups are coded. According to some embodiments, the transform coefficient of each point cloud group includes one first transform coefficient DC and at least one second transform coefficient {AC}. The arrangement manner of the transform coefficients is limited by the computer device (the coding device). For example, for the transform coefficients of points of the even number of cache limit parameters, or the number of point cloud groups in the cache is an even number, arrangement is [DC1, . . . , DCM, {AC1}, . . . , {ACM}]. For transform coefficients of points of the odd number of cache limit parameters, or the number of point cloud groups in the cache is an odd number, arrangement is [{AC1}, . . . , {ACM}, DC1, . . . , DCM]. During the coding process, the computer device can use run-length coding to code the residuals of the attribute information of the to-be-coded point, count the number of consecutive points being a symbol in the residual of the attribute information of the to-be-coded points, and record the number as the run-length. If the symbol of the residual of the attribute information of the current to-be-coded point is a value (for example, 0), the value of the run-length is increased by 1. Each time the run-length reaches the delay threshold indicated by the delay limit parameter, the value of the run-length and the residual of the attribute information of the current to-be-coded point are coded, the run-length is set to 0, and recount is performed. If the symbol of the residual of the attribute information of the current to-be-coded point is a non-specific value (for example, non-0), the computer device first codes the value of the run-length, codes the residual of the attribute information of the current to-be-coded point, and sets the run-length to 0 and recounts.

As illustrated in FIG. 3, the coding process of the attribute information of the point cloud may be controlled based on one or both of the cache limit parameter and the delay limit parameter. Multiple to-be-coded points may be supported, or the attribute information of multiple to-be-coded point cloud groups may be arranged according to a preset arrangement manner, which improves the coding performance of the attribute information of the point cloud.

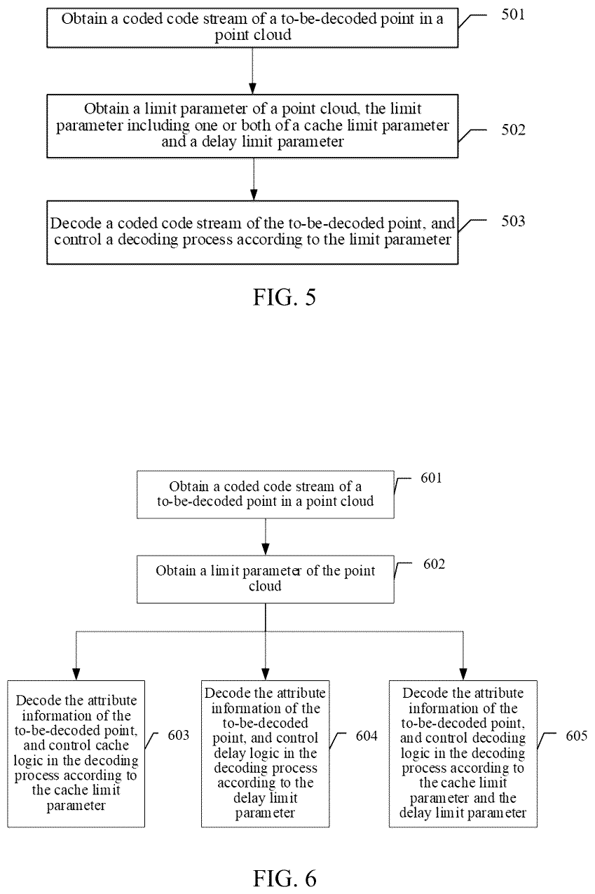

FIG. 5 shows another point cloud processing method according to some embodiments. The point cloud processing method can be executed by a computer device. The computer device can be the decoding device 202 in the point cloud processing system 20 shown in FIG. 2. As shown in FIG. 5, the point cloud processing method may include the following operation 501 to operation 503:

501: Obtain a coded code stream of a to-be-decoded point in a point cloud.

The coded code stream of the to-be-decoded point is obtained by coding a to-be-coded point by a coding device as illustrated in FIG. 3 and FIG. 4, for example. The coded code stream of the to-be-decoded point in the point cloud may be obtained by a computer device from the coding device in real time, or may be obtained by the computer device from downloaded coded code streams.

502: Obtain a limit parameter of a point cloud, the limit parameter including one or both of a cache limit parameter and a delay limit parameter.

The obtaining the limit parameter of the point cloud by the computer device includes any one or more of the following: parsing, from the coded code stream, to obtain the limit parameter that has been set to a fixed value; parsing, from the coded code stream, to obtain the limit parameter that has been set to a variable value; and parsing, from the coded code stream, to obtain a dynamically adjusted limit parameter that has been set. If the limit parameter of the point cloud is not obtained through parsing from the coded code stream, the computer device determines that the limit parameter of the point cloud is a default value. Various setting manners are used to limit the limit parameter, and the decoding delay can be flexibly controlled, which may determine decoding performance of attribute information of the point cloud in various scenarios.

According to some embodiments, based on the limit parameter including one type of parameter, a unit of the limit parameter includes any one of the following: a unit of a number of points and a unit of a number of groups. Limiting in unit of a number of points means limiting the number of to-be-decoded points based on decoding in unit of a number of points. Limiting in unit of a number of groups means limiting the number of to-be-decoded groups based on decoding in unit of a number of groups. When the limit parameter is a cache limit parameter, the decoding limit point number threshold is a cache limit point number threshold. The unit of the cache limit parameter can be a number of points or a number of groups. Based on the limit parameter being a delay limit parameter, the decoding limit point number threshold is a delay limit point number threshold. The unit of the delay limit parameter can be a number of points or a number of groups.

According to some embodiments, based on the limit parameter including two types of parameters, a unit of the limit parameter includes any one or more of the following: unit of a number of points, unit of a number of groups, and unit of a multiple relationship. A limit parameter 1 being in unit of a multiple refers to: based on a limit parameter 2 limiting the number of to-be-decoded points in unit of a number of points, the limit parameter 1 limits the number of to-be-decoded points in unit of a number of points, and the number of to-be-decoded points limited by the limit parameter 1 is a multiple of the number of to-be-decoded points limited by the limit parameter 2. When the limit parameter 2 limits the number of to-be-decoded groups in unit of a number of groups, the limit parameter 1 limits the number of to-be-decoded groups in unit of a number of groups, and the number of to-be-decoded groups limited by the limit parameter 1 is a multiple of the number of to-be-decoded groups limited by the limit parameter 2.

It can be known from the foregoing that a combination manner includes: the limit parameter 1 and the limit parameter 2 are both in unit of a number of points or in unit of a number of groups; the limit parameter 1 is in unit of a number of points, and the limit parameter 2 is in unit of a number of groups, or the limit parameter 2 is in unit of a multiple; and the limit parameter 1 is in unit of a number of groups, and the limit parameter 2 is in unit of a number of points, or the limit parameter 2 is in unit of a multiple. The limit parameter 1 may be any one of the cache limit parameter and the delay limit parameter, and the limit parameter 2 may be the other one of the cache limit parameter and the delay limit parameter. The limit parameter includes the number of parameter types, and the corresponding units are flexibly set, so that the decoding delay can be flexibly controlled, which may determine the decoding performance of the attribute information of the point cloud in various scenarios.

503: Decode the coded code stream of the to-be-decoded point, and control a decoding process according to the limit parameter.

The decoding scheme includes run-length decoding. If the coding device codes in unit of a number of points, the computer device decodes in unit of a number of points. If the coding device codes in unit of a number of groups, the computer device decodes in unit of a number of groups. The limit parameter may include at least one of a cache limit parameter and a delay limit parameter.

In implementation 1, according to some embodiments, the computer device controlling the decoding process according to the limit parameter is: determining a limit point number threshold according to the limit parameter, where the limit point number threshold is used to limit a number threshold of to-be-decoded points. For example, if the limit parameter is a cache limit parameter, the computer device determines, according to the cache limit parameter, a threshold number of to-be-decoded points that are allowed to be cached in the cache. If the limit parameter is a delay limit parameter, the computer device determines, according to the delay limit parameter, a threshold number of to-be-decoded points that are allowed to be delayed in the decoding process. During run-length decoding, if the computer device reads a limit flag bit, a count value of a first run-length is set to a preset value (for example, the limit point number threshold). If the count value of the first run-length is greater than zero and is not equal to the limit point number threshold, the computer device sets the intermediate coefficient of the current to-be-decoded point to a value (for example, 0), and reduces the count value of the first run-length by one step, until the count value of the first run-length is equal to zero. The computer device obtains the intermediate coefficient of the to-be-decoded point that is read based on the count value of the first run-length being equal to zero, and performs decoding. In some embodiments, during the run-length decoding process, the first run-length is used to control the decoding according to the limit point number threshold, which may determine the coding and decoding performance of the attribute information of the point cloud.

In implementation 2, according to some embodiments, the computer device controlling the decoding process according to the limit parameter is: determining a limit point number threshold according to the limit parameter, where the limit point number threshold is used to limit a number threshold of to-be-decoded points. A count value of a first run-length is read from the coded code stream during the run-length decoding; if the count value of the first run-length is greater than zero and equal to the limit point number threshold, the computer device sets the intermediate coefficient of the current to-be-decoded point to a value, and reduces the count value of the first run-length by one step, until the count value of the first run-length is equal to zero; reads a count value of a second run-length from the coded code stream; and if the count value of the second run-length is greater than zero and not equal to the limit point number threshold, sets the intermediate coefficient of the current to-be-decoded point to a preset value, and reduces the count value of the second run-length by one step, until the count value of the second run-length is equal to zero; obtains the intermediate coefficient of the to-be-decoded point that is read based on the count value of the second run-length being equal to zero, and performs decoding. The second run-length is a next run-length of the first run-length. If the count value of the second run-length is greater than zero and equal to the limit point number threshold, the computer device sets the intermediate coefficient of the current to-be-decoded point to a value, and reduces the count value of the second run-length by one step, until the count value of the second run-length is equal to zero; and reads a count value of a third run-length from the coded code stream and continues to make judgment. For example, if the count value of the read run-length is greater than zero and equal to the limit point number threshold, based on the count value of the run-length being 0, the computer device continues to read the count value of the next run-length. If the count value of the read run-length is greater than zero and not equal to the limit point number threshold, based on the count value of the run-length being 0, the computer device obtains the intermediate coefficient of the to-be-decoded point that is read based on the count value of the run-length being equal to zero, and performs decoding. In some embodiments, during the run-length decoding process, the first run-length and the second run-length are used to control the decoding according to the limit point number threshold, which may determine the coding and decoding performance of the attribute information of the point cloud.

In implementation 3, according to some embodiments, during the run-length decoding process, the computer device reads the count value of the first run-length from the coded code stream. If the count value of the first run-length is greater than zero, the computer device sets the intermediate coefficient of the current to-be-decoded point to a value, and reduces the count value of the first run-length by one step, until the count value of the first run-length is equal to zero; obtains the intermediate coefficient of the to-be-decoded point that is read based on the count value of the first run-length being equal to zero, and performs decoding. The intermediate coefficient of the to-be-decoded point that is read based on the count value of the first run-length being equal to zero may be a value. The intermediate coefficients whose values are the value may be accumulated in multiple run-lengths. In some embodiments, during the run-length decoding process, the intermediate coefficients read based on the count value being 0 are decoded, which may determine the coding and decoding performance of the attribute information of the point cloud.

In the coding scheme in unit of a group, the decoding process is similar to the implementation 1 to implementation 3. The difference is that based on the limit parameter being a cache limit parameter, based on caching the read intermediate parameters of the point cloud groups, the computer device may also arrange the intermediate coefficients of point cloud groups in the cache according to an obtained arrangement manner, and may decode according to implementation 1 to implementation 3.

According to some embodiments, the decoding scheme is in unit of a number of points, for example, a point in the point cloud is decoded as a decoding unit. According to some embodiments, a computer device decoding the coded code stream of the to-be-decoded point is: parsing the coded code stream of the to-be-decoded point to obtain the intermediate coefficient of the to-be-decoded point, where the intermediate coefficient includes a residual coefficient or a transform coefficient, and writing, by the computer device, the intermediate coefficient of the to-be-decoded point in the cache and reading the intermediate coefficient of the to-be-decoded point from the cache for decoding. During the decoding process, the computer device can control the decoding process based on the limit parameter. For example, the computer device may control the decoding process based on the delay limit parameter. For another example, the computer device may control the decoding process based on the cache limit parameter. For another example, the computer device may control the decoding process based on the cache limit parameter and the delay limit parameter. The above descriptions of point cloud decoding may be considered for implementation of the computer device decoding the coded code stream. In some embodiments, the attribute information of the to-be-decoded point is converted in unit of a number of points, and the obtained intermediate coefficient is written in the cache, so that the intermediate coefficient is read from the cache for decoding, which can control the delay of the point cloud coding process, avoid an excessively long waiting time for point cloud decoding, and help improve the coding and decoding performance of attribute information of the point cloud.

According to some embodiments, the decoding scheme is in unit of a number of groups, for example, a group in the point cloud is decoded as a decoding unit. According to some embodiments, the computer device decoding the coded code stream of the to-be-decoded point is: parsing the coded code stream of the to-be-decoded point to obtain multiple point cloud groups, where each point cloud group includes the intermediate coefficient of the to-be-decoded point, and the intermediate coefficient includes a residual coefficient or a transform coefficient, and writing, by the computer device, the point cloud group to the cache, and sequentially reading the intermediate coefficients of the to-be-decoded points in the point cloud group from the cache for decoding. During the decoding process, the computer device can control the decoding process based on the limit parameter. For example, the computer device may control the decoding process based on the delay limit parameter. For another example, the computer device may control the decoding process based on the cache limit parameter. For another example, the computer device may control the decoding process based on the cache limit parameter and the delay limit parameter. The above descriptions of point cloud decoding may be considered for implementation of the computer device decoding the coded code stream. In some embodiments, the attribute information of the to-be-decoded point is converted in unit of a number of groups, and the obtained intermediate coefficient is written in the cache, so that the intermediate coefficient is read from the cache for decoding, which can control the delay of the point cloud coding process, avoid an excessively long waiting time for point cloud decoding, and help improve the coding and decoding performance of attribute information of the point cloud.

In some embodiments, based on the to-be-decoded point in the point cloud to be decoded, the coded code stream of the to-be-decoded point in the point cloud and the limit parameter of the point cloud can be obtained, the coded code stream of the to-be-decoded point is decoded, and the decoding process is applied according to the limit parameter. In some embodiments, the decoding process of attribute information of the to-be-decoded point is applied by obtaining the limit parameter of the point cloud, which may improve the decoding performance of the attribute information of the point cloud.

FIG. 6 shows another point cloud processing method according to some embodiments. The point cloud processing method can be executed by a computer device. The computer device can be the decoding device 202 in the point cloud processing system 20 shown in FIG. 2. As shown in FIG. 5, the point cloud processing method may include the following operation 601 to operation 605:

601: Obtain a coded code stream of a to-be-decoded point in a point cloud.

602: Obtain a limit parameter of the point cloud.

According to some embodiments of operation 601 and operation 602, refer to the descriptions of operation 501 and operation 502 in FIG. 5.

When the limit parameter is a cache limit parameter, operation 603 is performed. When the limit parameter is a delay limit parameter, operation 604 is performed. When the limit parameter includes a cache limit parameter and a delay limit parameter, operation 605 is performed.

603: Decode the attribute information of the to-be-decoded point, and control cache logic in a decoding process according to the cache limit parameter.

The cache limit parameter is used to control the number of to-be-decoded points that are allowed to be written in the cache, so that the decoding process of attribute information of the to-be-decoded point may be controlled, which can avoid an excessively long waiting time for point cloud decoding, which may improve the decoding performance of the attribute information of the point cloud. According to some embodiments, the cache limit parameter is used to limit the number of to-be-decoded points that are allowed to be written in the cache, and each to-be-decoded point may include one or more intermediate coefficients. The computer device determines a cache limit point number threshold according to the cache limit parameter. Each time the number of to-be-decoded points written in the cache reaches the cache limit point number threshold, the computer device reads the intermediate coefficient of the to-be-decoded point from the cache for decoding. In some embodiments, the cache limit point number threshold determined based on the cache limit parameter is used to control the number of to-be-decoded point that are allowed to be written in the cache. When the number of to-be-decoded points that are allowed to be written in the cache reaches the cache limit point number threshold, decoding is triggered, which can avoid an excessively long waiting time for point cloud decoding, which may improve the decoding performance of the attribute information of the point cloud.

In some embodiments, the decoding scheme is in unit of a number of groups, for example, a group in the point cloud is decoded as a decoding unit. The computer device counts the total number of to-be-decoded points included in each point cloud group in the cache. When the number of groups stored in the cache is M, and the total number of to-be-decoded points included in the M point cloud groups reaches the cache limit point number threshold, the computer device reads the intermediate coefficient of the to-be-decoded point included in the M point cloud groups from the cache for decoding. Further, the computer device clears the cache and continues to write the intermediate coefficients of the to-be-decoded point in the cache. In some embodiments, based on decoding in unit of a number of groups, the total number of to-be-decoded points in all point cloud groups is controlled by the cache limit point number threshold, to control delay on the decoding process of the attribute information of the to-be-decoded point, which helps improve decoding performance of the attribute information of the point cloud.

In some embodiments, the decoding scheme is in unit of a number of groups, for example, a group in the point cloud is decoded as a decoding unit. The computer device counts the total number of target to-be-decoded points included in each point cloud group in the cache. The number of target to-be-decoded points in each point cloud group is less than or equal to the point number limit threshold of each point cloud group. If the cache includes M point cloud groups, and the total number of target to-be-decoded points included in the M point cloud groups reaches the cache limit point number threshold, the computer device reads the intermediate coefficients of the to-be-decoded points included in the M point cloud groups from the cache for decoding. Further, the computer device clears the cache and continues to write the intermediate coefficient of the to-be-decoded point in the cache. In some embodiments, based on decoding in unit of a number of groups, the number of to-be-decoded points in each point cloud group is controlled by the point number limit threshold, and the total number of to-be-decoded points in all point cloud groups is controlled by the cache limit point number threshold, to control delay on the decoding process of the attribute information of the to-be-decoded point, which helps improve decoding performance of the attribute information of the point cloud.

According to some embodiments, the decoding scheme is in unit of a number of groups, for example, a group (a group may include at least one point in the point cloud) in the point cloud is decoded as a decoding unit. The computer device counts the number M of point cloud groups included in the cache, and calculates, based on M and the point number limit threshold of the point cloud group, the total number of to-be-decoded points included in the cache. For example, assuming M=64 and the point number limit threshold is 8, the total number of to-be-decoded points included in the cache is 64*8=512. If the total number of to-be-decoded points included in the cache reaches the cache limit point number threshold, the computer device reads the intermediate coefficients of the to-be-decoded points included in the M point cloud groups from the cache for decoding. Further, the computer device clears the cache and continues to write the intermediate coefficient of the to-be-decoded point in the cache. In some embodiments, based on decoding in unit of a number of groups, delay is applied, based on the group number threshold, on the number of point cloud groups allowed to be written in the cache, which helps improve the decoding performance of the attribute information of the point cloud.

In some embodiments, during the decoding process, the computer device may also obtain a preset arrangement manner of point cloud groups in the cache. The preset arrangement manner includes any one of the following: a fixed arrangement manner and a dynamic arrangement manner. The fixed arrangement manner means that an arrangement manner of intermediate coefficients of the point cloud groups cached each time is the same (for example, according to similarity, or according to the number of to-be-coded points included in the group), and the dynamic arrangement manner means that an arrangement manner of intermediate coefficients of the point cloud groups in the cache changes. For example, the arrangement manner of the intermediate coefficients of the point cloud group cached for the first time is the same as the arrangement manner of the intermediate coefficients of the point cloud group cached for the second time, and the arrangement manner of the intermediate coefficients of the point cloud group cached for the third time is different. In some embodiments, the point cloud groups written in the cache are arranged in either a fixed arrangement manner or a dynamic arrangement manner, which may provide orderly decoding of the point cloud and help improve the decoding processing efficiency of the decoded code stream. According to some embodiments, the computer device obtaining the preset arrangement manner of the point cloud groups in the cache is: each arrangement corresponds to an index value, and the computer device can parse to obtain the index value from the coded code stream and determine the arrangement manner of the point cloud groups based on the index value. In some embodiments, by writing the index value corresponding to the arrangement manner of the intermediate coefficients of the point cloud group in the decoded code stream, it is convenient to decode the decoded code stream based on the index value, which helps improve the decoding processing efficiency of the decoded code stream.

604: Decode the attribute information of the to-be-decoded point, and control delay logic in a decoding process according to the delay limit parameter.

According to some embodiments of operation 604, refer to the descriptions of operation 503 shown in FIG. 5. The delay limit parameter is used to perform delay control on the number of to-be-decoded points, so that the decoding process of attribute information of the to-be-decoded point may be controlled, which can avoid an excessively long waiting time for point cloud decoding, which may improve the decoding performance of the attribute information of the point cloud.

605: Decode the attribute information of the to-be-decoded point, and control decoding logic in a decoding process according to the cache limit parameter and the delay limit parameter.

The cache limit parameter and the delay limit parameter are used to perform delay control on the number of to-be-decoded points, so that the decoding process of attribute information of the to-be-decoded point may be controlled, which can avoid an excessively long waiting time for point cloud coding, which may improve the decoding performance of the attribute information of the point cloud. According to some embodiments, the cache limit parameter and the delay limit parameter are independent of each other. The computer device first reads the intermediate parameter of the to-be-decoded point or the intermediate parameter of the point cloud group into the cache according to the delay limit parameter. According to some embodiments, refer to the descriptions of operation 604. If the coding device codes in unit of a group, based on caching the read intermediate parameters of the point cloud groups, the computer device can also arrange the intermediate coefficients of the point cloud groups in the cache according to the obtained arrangement manner. The computer device may control the decoding logic in the decoding process according to the delay limit parameter. According to some embodiments, refer to the descriptions of operation 503.

According to some embodiments, the cache limit parameter and the delay limit parameter are correlated with each other. For example, the cache limit parameter is determined based on the delay limit parameter, or the delay limit parameter is determined based on the cache limit parameter. The computer device first reads the intermediate parameter of the to-be-decoded point or the intermediate parameter of the point cloud group into the cache according to the delay limit parameter. According to some embodiments, refer to the descriptions of operation 604. If the coding device codes in unit of a group, based on caching the read intermediate parameters of the point cloud groups, the computer device can also arrange the intermediate coefficients of the point cloud groups in the cache according to the obtained arrangement manner. The computer device may control the decoding logic in the decoding process according to the delay limit parameter. According to some embodiments, refer to the descriptions of operation 503.

As illustrated in FIG. 5, the decoding process of the attribute information of the point cloud may be applied by using one or both of the cache limit parameter and the delay limit parameter. Multiple to-be-decoded points may be supported, or the attribute information of multiple to-be-decoded point cloud groups may be arranged according to the arrangement manner indicated by the coded code stream, which improves the decoding performance of the attribute information of the point cloud.

The above provides a description of the methods according to some embodiments. An apparatus according to some embodiments is provided below.

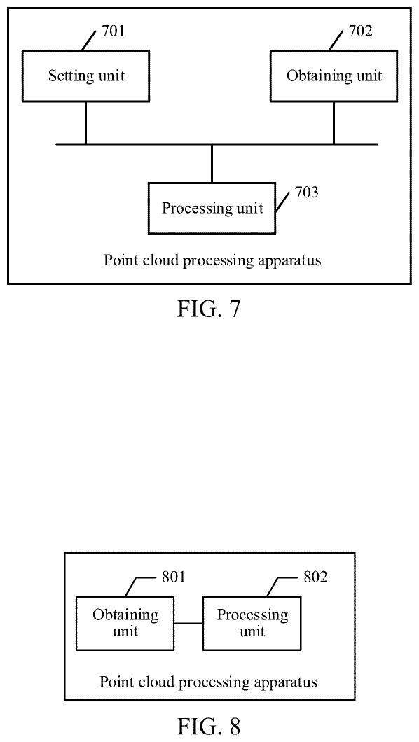

FIG. 7 is a schematic structural diagram of a point cloud processing apparatus according to some embodiments. The point cloud processing apparatus may be a computer-readable instruction (including program code) running in a coding device. For example, the point cloud processing apparatus may be application software in the coding device. As shown in FIG. 7, the point cloud processing apparatus includes a setting unit 701, an obtaining unit 702, and a processing unit 703. Referring to FIG. 7, detailed description of each unit is as follows:

The setting unit 701 may be configured to set a limit parameter of a point cloud, the limit parameter including one or both of a cache limit parameter and a delay limit parameter.

The obtaining unit 702 may be configured to obtain attribute information of a to-be-coded point in the point cloud.

The processing unit 703 may be configured to code the attribute information of the to-be-coded point; and control a coding process according to the limit parameter.

According to some embodiments, a coding scheme of the coding includes a coding scheme in unit of a number of points; and based on coding the attribute information of the to-be-coded point, the processing unit 703 is configured to: convert the attribute information of the to-be-coded point, to obtain an intermediate coefficient of the to-be-coded point; where the intermediate coefficient includes a residual coefficient or a transform coefficient; write the intermediate coefficient of the to-be-coded point in a cache; and read the intermediate coefficient of the to-be-coded point from the cache for coding.

According to some embodiments, a coding scheme of the coding includes a coding scheme in unit of a number of groups; and based on coding the attribute information of the to-be-coded point, the processing unit 703 may be configured to: group attribute information of to-be-coded points, to obtain multiple point cloud groups; convert attribute information of a to-be-coded point in the point cloud group, to obtain a converted point cloud group, where the converted point cloud group includes an intermediate coefficient of the to-be-coded point; and the intermediate coefficient includes a residual coefficient or a transform coefficient; write the converted point cloud group in a cache; and sequentially read the intermediate coefficient of the to-be-coded point in the converted point cloud group from the cache for coding.

According to some embodiments, the limit parameter includes a cache limit parameter; and based on controlling the coding process according to the limit parameter, the processing unit 703 may be configured to: control cache logic in the coding process according to the cache limit parameter.

According to some embodiments, based on controlling cache logic in the coding process according to the cache limit parameter, the processing unit 703 may be configured to: determine a cache limit point number threshold according to the cache limit parameter, where the cache limit point number threshold is used to limit a number threshold of to-be-coded points that are allowed to be written in the cache; and each time a number of to-be-coded points written in the cache reaches the cache limit point number threshold, read the intermediate coefficient of the to-be-coded point from the cache for coding.

According to some embodiments, a coding scheme of the coding includes a coding scheme in unit of a number of groups; and each time a number of to-be-coded points written in the cache reaches the cache limit point number threshold, based on reading the intermediate coefficient of the to-be-coded point from the cache for coding, the processing unit 703 may be configured to: count a total number of to-be-coded points included in each point cloud group in the cache, and if the cache includes M point cloud groups and a total number of to-be-coded points included in the M point cloud groups reaches the cache limit point number threshold, read an intermediate coefficient of a to-be-coded point included in the M point cloud groups from the cache for coding; or count a number M of point cloud groups included in the cache, calculate a total number of to-be-coded points in the cache based on M and a point number limit threshold of the point cloud group, and if the total number of to-be-coded points in the cache reaches the cache limit point number threshold, read an intermediate coefficient of a to-be-coded point included in the M point cloud groups from the cache for coding.

According to some embodiments, a coding scheme of the coding includes a coding scheme in unit of a number of groups; and based on controlling cache logic in the coding process according to the cache limit parameter, the processing unit 703 may be configured to: determine, according to the cache limit parameter, a number threshold of point cloud groups allowed to be written in the cache; and each time the number of point cloud groups written in the cache reaches the group number threshold, read, from the cache for coding, the intermediate coefficient of the to-be-coded point included in the point cloud groups written in the cache.

According to some embodiments, the processing unit 703 is further configured to: arrange, according to a preset arrangement manner, the point cloud groups written in the cache; where the preset arrangement manner includes any one of the following: a fixed arrangement manner and a dynamic arrangement manner; and the fixed arrangement manner means that an arrangement manner of intermediate coefficients of the point cloud groups in the cache is fixed, and the dynamic arrangement manner means that an arrangement manner of intermediate coefficients of the point cloud groups in the cache changes.

According to some embodiments, each arrangement manner corresponds to an index value; and the processing unit 703 is further configured to: write an index value corresponding to an arrangement manner of the intermediate coefficients of the point cloud groups in the cache in a coded code stream formed by the coding.

According to some embodiments, the coding includes run-length coding; and based on controlling cache logic in the coding process according to the cache limit parameter, the processing unit 703 may be configured to: determine, according to the cache limit parameter, a cache limit point number threshold of to-be-coded points that are allowed to be written in the cache, where the cache limit point number threshold is used to limit a number threshold of to-be-coded points that are allowed to be written in the cache during the coding process; set, during run-length coding, a run-length used to count consecutive symbols; set the run-length to an initial value, and in a process of sequentially reading the intermediate coefficients of the to-be-coded points from the cache: if an intermediate coefficient whose value is a symbol is read, increase a count value of the run-length by one step; if a number of to-be-coded points that are read is equal to the cache limit point number threshold, code the current run-length, or code the cache limit point number threshold and an intermediate coefficient of a to-be-coded point whose value is a symbol, and set the run-length to the initial value for recount; and if an intermediate coefficient of a to-be-coded point whose value is a non-specific symbol is read, code the current run-length and the intermediate coefficient of the non-specific symbol, and reset the run-length to the initial value for recount.

According to some embodiments, the limit parameter includes a delay limit parameter; and based on controlling the coding process based on the limit parameter, the processing unit 703 may be configured to: control delay logic in the coding process according to the delay limit parameter.

According to some embodiments, the coding includes run-length coding; and based on controlling delay logic in the coding process according to the delay limit parameter, the processing unit 703 may be configured to: determine a delay limit point number threshold according to the delay limit parameter, where the delay limit point number threshold is used to limit a number threshold of to-be-coded points that are allowed to be delayed during coding; set, during run-length coding, a run-length used to count consecutive symbols; set the run-length to an initial value, and in a process of sequentially reading the intermediate coefficients of the to-be-coded points from the cache: if an intermediate coefficient whose value is a symbol is read, increase a count value of the run-length by one step; obtain a count value of the run-length, and if the count value of the run-length reaches the delay limit point number threshold, perform parameter coding processing and reset the run-length to the initial value for recount; and if an intermediate coefficient of a to-be-coded point whose value is a non-specific symbol is read, code the current run-length and the intermediate coefficient of the non-specific symbol, and reset the run-length to the initial value for recount; where the parameter coding processing refers to: coding the current run-length; or coding a limit identifier, where the limit identifier may be configured for setting the run-length to a preset value; or coding the delay limit point number threshold and the intermediate coefficient of the to-be-coded point whose value is a symbol.

According to some embodiments, the coding includes run-length coding; and based on controlling delay logic in the coding process according to the delay limit parameter, the processing unit 703 may be configured to: determine a delay limit point number threshold according to the delay limit parameter, where the delay limit point number threshold is used to limit a number threshold of to-be-coded points that are allowed to be delayed during coding; set, during run-length coding, a run-length used to count consecutive symbols; set the run-length to an initial value, and in a process of sequentially reading the intermediate coefficients of the to-be-coded points from the cache: if an intermediate coefficient whose value is a symbol is read, increase a count value of the run-length by one step; if a number of to-be-coded points reaches the delay limit point number threshold, code the current run-length, or code the delay limit point number threshold and an intermediate coefficient of a to-be-coded point whose value is a symbol, and reset the run-length to the initial value for recount; and if an intermediate coefficient of a to-be-coded point whose value is a non-specific symbol is read, code the current run-length and the intermediate coefficient of the non-specific symbol, and reset the run-length to the initial value for recount.

According to some embodiments, the delay limit parameter may be configured for determining the delay limit point number threshold; the coding includes run-length coding, and the run-length in the run-length coding is less than or equal to the delay limit point number threshold; and the processing unit 703 is further configured to: setting a number of bits of the run-length according to the delay limit point number threshold.

According to some embodiments, the limit parameter includes a cache limit parameter and a delay limit parameter; and based on controlling the coding process based on the limit parameter, the processing unit 703 may be configured to: control coding logic in the coding process according to the cache limit parameter and the delay limit parameter.

According to some embodiments, a setting manner of the limit parameter includes any one or more of the following: setting the limit parameter to a default value; setting the limit parameter to a fixed value, and encapsulating the set limit parameter into the coded code stream formed by the coding; setting the limit parameter to a variable value, and encapsulating the set limit parameter into the coded code stream formed by the coding; and dynamically adjusting the value of the limit parameter during the coding process, and encapsulating the dynamically adjusted limit parameter into the coded code stream formed by the coding.

According to some embodiments, based on the limit parameter including one type of parameter, a unit of the limit parameter includes any one of the following: a unit of a number of points and a unit of a number of groups; and based on the limit parameter including two types of parameters, the unit of the limit parameter includes any one or more of the following: unit of a number of points, unit of a number of groups, and unit of a multiple relationship.

According to some embodiments, the limit parameter may be configured for determining a coding limit point number threshold; if the limit parameter is a cache limit parameter, the coding limit point number threshold is a cache limit point number threshold; if the limit parameter is a delay limit parameter, the coding limit point number threshold is a delay limit point number threshold; if the limit parameter is in unit of a number of points and the value of the limit parameter is X1, the coding limit point number threshold is an actual total number of intermediate coefficients of X1 to-be-coded points; if the limit parameter is in unit of a number of groups and the value of the limit parameter is X2, the coding limit point number threshold is an actual total number of intermediate coefficients of to-be-coded points in X2 point cloud groups; and if the limit parameter is in unit of a number of groups, the value of the limit parameter is X3, and a number of points in each point cloud group is limited to X4, the coding limit point number threshold is a total number of intermediate coefficients of to-be-coded points in X3 point cloud groups, where the total number does not exceed the value of X3*X4.

According to some embodiments, the limit parameter includes two types of parameters: a cache limit parameter and a delay limit parameter; the cache limit parameter may be configured for determining a cache limit point number threshold; the delay limit parameter may be configured for determining the delay limit point number threshold; if the cache limit parameter is in unit of a multiple relationship and the value of the cache limit parameter is Y1, the cache limit point number threshold is Y1 times the delay limit point number threshold; and if the delay limit parameter is in unit of a multiple relationship and the value of the delay limit parameter is Y2, the delay limit point number threshold is Y2 times the cache limit point number threshold.

According to some embodiments, some of the operations involved in the point cloud processing methods shown in FIG. 3 and FIG. 4 may be performed by various units in the point cloud processing apparatus shown in FIG. 7. For example, operation 301 shown in FIG. 3 can be executed by the setting unit 701 shown in FIG. 7, operation 302 can be executed by the obtaining unit 702 shown in FIG. 7, and operation 303 can be executed by the processing unit 703 shown in FIG. 7. Operation 401 shown in FIG. 4 can be executed by the setting unit 701 shown in FIG. 7, operation 402 can be executed by the obtaining unit 702 shown in FIG. 7, and operation 403 to operation 405 can be executed by the processing unit 703 shown in FIG. 7. The units of the point cloud processing apparatus shown in FIG. 7 may be separately or wholly combined into one or several other units, or one (or more) of the units herein may further be divided into multiple units of smaller functions. Same operations may be implemented, and implementation of the technical effects of some embodiments may not be affected. The foregoing units are divided based on logical functions. In an actual application, a function of one unit may be implemented by multiple units, or functions of multiple units are implemented by one unit. In some embodiments, the point cloud processing apparatus may also include another unit. During practical application, these functions may also be cooperatively implemented by another unit and may be cooperatively implemented by multiple units.

According to some embodiments, a computer-readable instruction (including program code) that can perform operations of the corresponding methods shown in FIG. 3 and FIG. 4 may be run on a computing apparatus, for example, a computer, that includes a processing element and a storage element such as a central processing unit (CPU), a random access memory (RAM), and a read-only memory (ROM), to construct the point cloud processing apparatus shown in FIG. 7, and to implement the point cloud processing method according to some embodiments. The computer-readable instruction may be recorded in, for example, a computer-readable recording medium, and may be loaded into the foregoing computing apparatus by using the computer-readable recording medium, and run in the computing apparatus.

The principles and effects for solving problems in the point cloud processing method according to some embodiments may be applied to the point cloud processing apparatus according to some embodiments.

FIG. 8 is a schematic structural diagram of another point cloud processing apparatus according to some embodiments. The point cloud processing apparatus may be a computer-readable instruction (including program code) running in a decoding device. For example, the point cloud processing apparatus may be application software in the decoding device. As shown in FIG. 8, the point cloud processing apparatus includes an obtaining unit 801 and a processing unit 802. Referring to FIG. 8, detailed description of each unit is as follows:

The obtaining unit 801 may be configured to obtain a coded code stream of a to-be-decoded point in a point cloud, and obtain a limit parameter of the point cloud, the limit parameter including one or both of a cache limit parameter and a delay limit parameter.

The processing unit 802 may be configured to decode the coded code stream of the to-be-decoded point; and control a decoding process according to the limit parameter.

According to some embodiments, the obtaining unit 801 obtaining a limit parameter of the point cloud includes any one or more of the following: setting the limit parameter to a default value; parsing, from the coded code stream, to obtain the limit parameter that has been set to a fixed value; parsing, from the coded code stream, to obtain the limit parameter that has been set to a variable value; and parsing, from the coded code stream, to obtain a dynamically adjusted limit parameter that has been set.

According to some embodiments, a decoding scheme of the decoding includes a decoding scheme in unit of a number of points; and based on decoding the coded code stream of the to-be-decoded point, the processing unit 802 may be configured to: parse the coded code stream of the to-be-decoded point to obtain an intermediate coefficient of the to-be-decoded point; where the intermediate coefficient includes a residual coefficient or a transform coefficient; write the intermediate coefficient of the to-be-decoded point in a cache; and read the intermediate coefficient of the to-be-decoded point from the cache for decoding.

According to some embodiments, a decoding scheme of the decoding includes a decoding scheme in unit of a number of groups; and based on decoding the coded code stream of the to-be-decoded point, the processing unit 802 may be configured to: parse the coded code stream of the to-be-decoded point to obtain multiple point cloud groups, where the point cloud group includes the intermediate coefficient of the to-be-decoded point, and the intermediate coefficient includes a residual coefficient or a transform coefficient; write the point cloud group in the cache; and sequentially read the intermediate coefficient of the to-be-decoded point in the point cloud group from the cache for decoding.

According to some embodiments, the decoding includes run-length decoding; and based on controlling the decoding process according to the limit parameter, the processing unit 802 may be configured to: determine a limit point number threshold according to the limit parameter, where the limit point number threshold is used to limit a number threshold of to-be-decoded points; if a limit flag bit is read during run-length decoding, set a count value of a first run-length to a preset value; if the count value of the first run-length is greater than zero and not equal to the limit point number threshold, set the intermediate coefficient of the current to-be-decoded point to a value, and reduce the count value of the first run-length by one step, until the count value of the first run-length is equal to zero; and obtain the intermediate coefficient of the to-be-decoded point that is read based on the count value of the first run-length being equal to zero, and perform decoding.

According to some embodiments, the decoding includes run-length decoding; and based on controlling the decoding process according to the limit parameter, the processing unit 802 may be configured to: determine a limit point number threshold according to the limit parameter, where the limit point number threshold is used to limit a number threshold of to-be-decoded points; read a count value of a first run-length from the coded code stream during the run-length decoding; if the count value of the first run-length is greater than zero and equal to the limit point number threshold, set the intermediate coefficient of the current to-be-decoded point to a value, and reduce the count value of the first run-length by one step, until the count value of the first run-length is equal to zero; read a count value of a second run-length from the coded code stream; and if the count value of the second run-length is greater than zero and not equal to the limit point number threshold, set the intermediate coefficient of the current to-be-decoded point to a preset value, and reduce the count value of the second run-length by one step, until the count value of the second run-length is equal to zero; and obtain the intermediate coefficient of the to-be-decoded point that is read based on the count value of the second run-length being equal to zero, and perform decoding.

According to some embodiments, the decoding includes run-length decoding; and based on controlling the decoding process according to the limit parameter, the processing unit 802 may be configured to: read a count value of a first run-length from the coded code stream during the run-length decoding; if the count value of the first run-length is greater than zero, set the intermediate coefficient of the current to-be-decoded point to a value, and reduce the count value of the first run-length by one step, until the count value of the first run-length is equal to zero; and obtain the intermediate coefficient of the to-be-decoded point that is read based on the count value of the first run-length being equal to zero, and perform decoding.

According to some embodiments, the limit parameter includes a cache limit parameter; and based on controlling the decoding process according to the limit parameter, the processing unit 802 may be configured to: control cache logic in the decoding process according to the cache limit parameter.

According to some embodiments, based on controlling cache logic in the decoding process according to the cache limit parameter, the processing unit 802 may be configured to: determine a cache limit point number threshold according to the cache limit parameter, where the cache limit point number threshold is used to limit a number threshold of to-be-decoded points that are allowed to be written in the cache; and each time a number of to-be-decoded points written in the cache reaches the cache limit point number threshold, read the intermediate coefficient of the to-be-decoded point from the cache for decoding.

According to some embodiments, a decoding scheme of the decoding includes a decoding scheme in unit of a number of groups; and each time a number of to-be-decoded points written in the cache reaches the cache limit point number threshold, based on reading the intermediate coefficient of the to-be-decoded point from the cache for decoding, the processing unit 802 may be configured to: count a total number of to-be-decoded points included in each point cloud group in the cache, and if the cache includes M point cloud groups and a total number of to-be-decoded points included in the M point cloud groups reaches the cache limit point number threshold, read an intermediate coefficient of a to-be-decoded point included in the M point cloud groups from the cache for decoding; or count a number M of point cloud groups included in the cache, calculate a total number of to-be-coded points in the cache based on M and a point number limit threshold of the point cloud group, and if the total number of to-be-coded points in the cache reaches the cache limit point number threshold, read an intermediate coefficient of a to-be-decoded point included in the M point cloud groups from the cache for decoding.

According to some embodiments, a decoding scheme of the decoding includes a decoding scheme in unit of a number of groups; and based on controlling the cache logic in the decoding process according to the cache limit parameter, the processing unit 802 may be configured to: determine, according to the cache limit parameter, a group number threshold of point cloud groups allowed to be written in the cache; and each time the number of point cloud groups written in the cache reaches the group number threshold, read, from the cache for decoding, the intermediate coefficient of the to-be-decoded point included in the point cloud groups written in the cache.

According to some embodiments, the processing unit 802 is further configured to: arrange, according to a preset arrangement manner, the point cloud groups written in the cache; where the preset arrangement manner includes any one of the following: a fixed arrangement manner and a dynamic arrangement manner; where the fixed arrangement manner means that an arrangement manner of intermediate coefficients of the point cloud groups in the cache is fixed, and the dynamic arrangement manner means that an arrangement manner of intermediate coefficients of the point cloud groups in the cache changes.

According to some embodiments, each arrangement manner corresponds to an index value; and the processing unit 802 is further configured to: parse to obtain an index value from the coded code stream, and determine an arrangement manner of the point cloud groups in the cache based on the index value.

According to some embodiments, the limit parameter includes a delay limit parameter; and based on controlling the decoding process according to the limit parameter, the processing unit 802 may be configured to: control delay logic in the decoding process according to the delay limit parameter.

According to some embodiments, the limit parameter includes a cache limit parameter and a delay limit parameter; and based on controlling the decoding process according to the limit parameter, the processing unit 802 may be configured to: control decoding logic in the decoding process according to the cache limit parameter and the delay limit parameter.

According to some embodiments, the limit parameter includes one or both of a cache limit parameter and a delay limit parameter; based on the limit parameter including one type of parameter, the unit of the limit parameter includes any one or more of the following: a unit of a number of points and a unit of a number of groups; and based on the limit parameter including two types of parameters, the unit of the limit parameter includes any one or more of the following: a unit of a number of points, a unit of a number of groups, and a unit of a multiple relationship.

According to some embodiments, some of the operations involved in the point cloud processing method shown in FIG. 5 and FIG. 6 may be performed by various units in the point cloud processing apparatus shown in FIG. 8. For example, operation 501 and operation 502 shown in FIG. 5 can be executed by the obtaining unit 801 shown in FIG. 8, and operation 503 can be executed by the processing unit 802 shown in FIG. 8. Operation 601 and operation 602 shown in FIG. 6 can be executed by the obtaining unit 801 shown in FIG. 8, and operation 603 to operation 605 can be executed by the processing unit 802 shown in FIG. 8. The units of the point cloud processing apparatus shown in FIG. 8 may be separately or wholly combined into one or several other units, or one (or more) of the units herein may further be divided into multiple units of smaller functions. The same operations may be implemented, and implementation of the technical effects of some embodiments may not be affected. The foregoing units are divided based on logical functions. In an actual application, a function of one unit may be implemented by multiple units, or functions of multiple units are implemented by one unit. In some embodiments, the point cloud processing apparatus may also include another unit. During practical application, these functions may also be cooperatively implemented by another unit and may be cooperatively implemented by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

According to some embodiments, a computer-readable instruction (including program code) that can perform operations of the corresponding method shown in FIG. 5 and FIG. 6 may be run on a computing apparatus, for example, a computer, that includes a processing element and a storage element such as a central processing unit (CPU), a random access memory (RAM), and a read-only memory (ROM), to construct the point cloud processing apparatus shown in FIG. 8, and to implement the point cloud processing method according to some embodiments. The computer-readable instruction may be recorded in, for example, a computer-readable recording medium, and may be loaded into the foregoing computing apparatus by using the computer-readable recording medium, and run in the computing apparatus.

The principles and effects of solving problems in the point cloud processing method may be applied to the point cloud processing apparatus.

FIG. 9 is a schematic structural diagram of a coding device according to some embodiments. The coding device may be a computer device used by a provider of point cloud media, and the computer device may be a terminal (for example, a PC or a smart mobile device (for example, a smartphone)) or a server. As shown in FIG. 9, the coding device includes a capture device 901, a processor 902, a memory 903, and a transmitter 904.

The capture device 901 may be configured to collect real-world sound-visual scenes to obtain original data of point cloud media (including audio content and video content that are synchronized in time and space). The capture device 901 may include but is not limited to: an audio device, a camera device, and a sensing device. The audio device may include an audio sensor, a microphone, and the like. The camera device can include a camera, a stereo camera, a light field camera, and the like. The sensing device may include a laser device, a radar device, and the like.

The processor 902 (or referred to as a central processing unit (CPU)) is the processing core of the coding device. The processor 902 may be configured to implement one or more computer-readable instructions, and may be configured to load and execute one or more computer-readable instructions to implement the flow of the point cloud processing methods shown in FIG. 3 and FIG. 4.

The memory 903 is a memory device in the coding device and may be configured to store computer-readable instructions and media resources. The memory 903 herein may include a built-in storage medium of the coding device, and may include an expanded storage medium supported by the coding device. The memory may be a high-speed RAM memory, or a non-volatile memory, for example, at least one magnetic disk storage. In some embodiments, the memory may further be at least one memory that is located far away from the foregoing processor. The memory provides a storage space for storing an operating system of the coding device. Moreover, the storage space is also configured to store computer-readable instructions. The computer-readable instructions include program instructions, and the program instructions are configured to be called and executed by the processor to execute each operation of the point cloud processing method. In addition, the memory 903 can also be configured to store point cloud media files formed based on processing by the processor. The point cloud media files include media file resources and media presentation description information.

The transmitter 904 may be configured to implement transmission interaction between the coding device and other devices, and may be configured to implement the transmission of point cloud media between the coding device and a content playback device. For example, the coding device transmits relevant media resources of the point cloud media to the content playback device through the transmitter 904.

Referring again to FIG. 9, the processor 902 may include a converter 921, a coder 922, and an encapsulator 923.

The converter 921 may be configured to perform a series of conversion processing on captured video content, so that the video content becomes content for video coding of point cloud media. The conversion processing may include: stitching and projection. In some embodiments, the conversion process further includes zone encapsulation. The converter 921 can convert captured 3D video content into a 2D image and provide the 2D image to the coder for video coding.

The coder 922 may be configured to perform audio coding on the captured audio content to form an audio code stream of the point cloud media, and is further configured to perform video coding on the 2D image converted by the converter 921, to obtain a video code stream.

The encapsulator 923 may be configured to encapsulate the audio code stream and the video code stream in a file container according to a file format (for example, ISOBMFF) of point cloud media, to form a media file resource of the point cloud media. The media file resource may be a media file or a media segment that forms a media file of point cloud media. According to a file format of the point cloud media, media presentation description information may be used to record metadata of the media file resources of the point cloud media. The encapsulated file of point cloud media processed by the encapsulator is saved in the memory and provided to the content playback device on demand for point cloud media presentation.

The processor 902 (or each device included in the processor) executes each operation of the point cloud processing methods shown in FIG. 3 and FIG. 4 by calling one or more instructions in the memory. The memory 903 stores one or more first instructions, and the one or more first instructions are loaded and executed by the processor 902 to implement the point cloud processing method according to some embodiments.

The principles and effects of solving problems by the point cloud processing method according to some embodiments may also be applied to the coding device according to some embodiments.

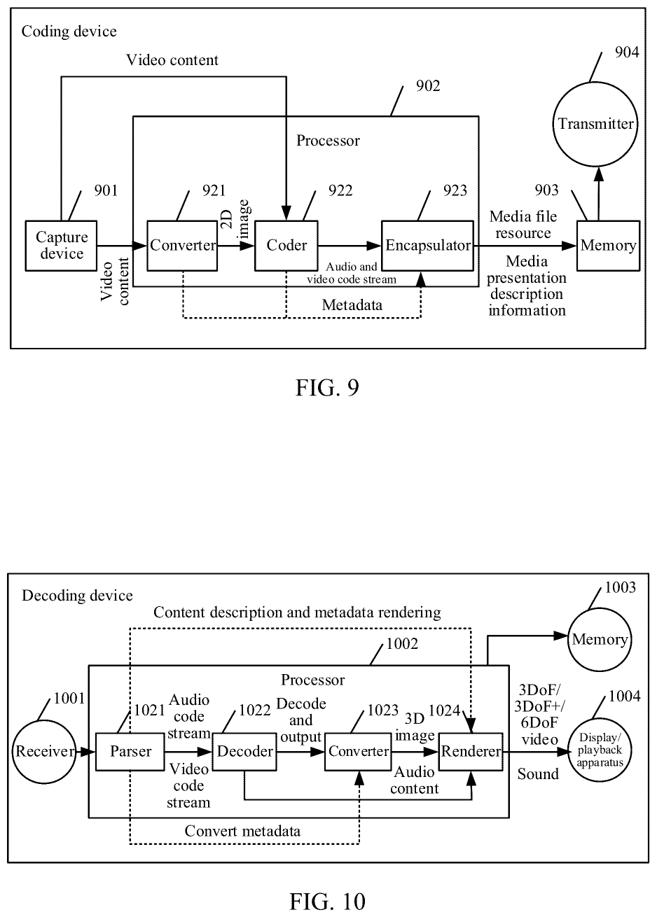

FIG. 10 is a schematic structural diagram of a decoding device according to some embodiments. The decoding device may be a computer device used by a user of point cloud media, and the computer device may be a terminal (for example, a PC or a smart mobile device (for example, a smartphone), or a VR device (for example, a VR helmet or VR glasses)). As shown in FIG. 10, the decoding device includes a receiver 1001, a processor 1002, a memory 1003, and a display/playback apparatus 1004.

The receiver 1001 may be configured to implement transmission interaction between the decoding device and other devices, and may be configured to implement point cloud media transmission between a coding device and the decoding device, for example, the decoding device receives, through the receiver 1001, relevant media resources of the point cloud media transmitted by the coding device.

The processor 1002 (or referred to as a central processing unit (CPU)) is the processing core of the decoding device. The processor 1002 may be configured to implement one or more computer-readable instructions, and may be configured to load and execute one or more computer-readable instructions to implement the flow of the point cloud processing methods shown in FIG. 5 and FIG. 6.

The memory 1003 is a memory device in the decoding device and may be configured to store computer-readable instructions and media resources. The memory 1003 herein may include a built-in storage medium of the decoding device, and may include an expanded storage medium supported by the decoding device. The memory 1003 may be a high-speed RAM memory, or a non-volatile memory, for example, at least one magnetic disk storage. In some embodiments, the memory may further be at least one memory that is located far away from the foregoing processor. The memory 1003 provides a storage space for storing an operating system of the decoding device. Moreover, the storage space is also configured to store computer-readable instructions. The computer-readable instructions include computer-readable instructions, and the computer-readable instructions are configured to be called and executed by the processor to execute each operation of the point cloud processing method. In addition, the memory 1003 can also be configured to store a three-dimensional image of the point cloud media formed based on processing by the processor, audio content corresponding to the three-dimensional image, information used for rendering the three-dimensional image and audio content, or the like. The display/playback apparatus 1004 may be configured to output rendered sound and three-dimensional images.

Referring again to FIG. 10, the processor 1002 may include a parser 1021, a decoder 1022, a converter 1023, and a renderer 1024.

The parser 1021 may be configured to decapsulate an encapsulated file of rendering media from the coding device, and decapsulate media file resources according to a file format of point cloud media to obtain an audio code stream and a video code stream; and provide the audio code stream and the video code stream to the decoder 1022.

The decoder 1022 performs audio decoding on the audio code stream, obtains audio content, and provides the audio content to the renderer for audio rendering. In addition, the decoder 1022 decodes the video code stream to obtain 2D images. According to metadata provided by media presentation description information, if the metadata indicates that the point cloud media has undergone a region encapsulation process, the 2D image is the encapsulated image. If the metadata indicates that the point cloud media has not undergone a region encapsulation process, the planar image is a projected image.

The converter 1023 may be configured to convert 2D images into 3D images. If the point cloud media has undergone a region encapsulation process, the converter 1023 may perform region decapsulation on the encapsulated image to obtain a projected image, and may reconstruct the projected image to obtain a 3D image. If the rendering media has not undergone a region encapsulation process, the converter 1023 may directly reconstruct the projected image to obtain a 3D image.

The renderer 1024 may be configured to render audio content and 3D images of point cloud media. Audio content and 3D images may be rendered according to metadata related to rendering and windows in media presentation description information, and based on the rendering being completed, may be transferred to the display/playback apparatus for output.

In some embodiments, the processor 1002 (or each device included in the processor) executes each operation of the point cloud processing methods shown in FIG. 5 and FIG. 6 by calling one or more instructions in the memory. The memory stores one or more first instructions, and the one or more first instructions are configured to be loaded by the processor 1002 to execute the point cloud processing method according to some embodiments.

The principles and effects of solving problems by the point cloud processing method according to some embodiments may also be applied to the decoding device according to some embodiments.

Some embodiments further provides a computer-readable storage medium, the computer-readable storage medium stores one or more computer-readable instructions, and the one or more computer-readable instructions are configured to be loaded and executed by the processor to implement the point cloud processing method according to some embodiments.

Some embodiments further provides a computer program product including instructions, and the computer program product, when run on a computer, causes the computer to perform the point cloud processing method according to some embodiments.

Some embodiments further provides a computer program product. The computer program product includes computer-readable instructions, and the computer-readable instructions are stored in a computer-readable storage medium. The processor of the computer device reads the computer-readable instructions from the computer-readable storage medium, and the processor executes the computer instructions, so that the computer device executes the point cloud processing method according to some embodiments.

The operations of the methods of some embodiments may be reordered or combined.

The modules of the apparatuses of some embodiments may be combined or divided.

A person of ordinary skill in the art may understand that all or some of the operations of the methods according to some embodiments may be implemented by a computer-readable instruction instructing relevant hardware. The computer-readable instruction may be stored in a computer-readable storage medium. The readable storage medium may include: a flash drive, a read-only memory (ROM), a random access memory (RAM), a magnetic disk, or an optical disc.

The foregoing embodiments are used for describing, instead of limiting the technical species of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A point cloud processing method, performed by a computer device, comprising:
setting a limit parameter of a point cloud;
obtaining attribute information of a first point of the point cloud to be coded;
coding the attribute information of the first point; and
transmitting the coded attribute information in a code stream,
wherein the coding the attribute information is controlled according to the limit parameter, and
wherein the limit parameter comprises at least one of a cache limit parameter or a delay limit parameter.

2. The method according to claim 1, wherein the coding the attribute information is based on a coding scheme in unit of a number of points, comprising:
converting the attribute information of the first point to obtain a first intermediate coefficient of the first point;
writing the first intermediate coefficient to a cache; and
reading the first intermediate coefficient from the cache for coding, and wherein the first intermediate coefficient comprises a residual coefficient or a transform coefficient.

3. The method according to claim 1, wherein the coding the attribute information is based on a coding scheme in unit of a number of groups, comprising:
grouping attribute information of a plurality of points to be coded, to obtain a first plurality of point cloud groups;
converting attribute information of a second point of a point cloud group to be coded, to obtain a converted point cloud group;
writing the converted point cloud group to a cache; and
sequentially reading a second intermediate coefficient of the second point from the cache for coding, and
wherein the second intermediate coefficient comprises a residual coefficient or a transform coefficient.

4. The method according to claim 3, wherein the limit parameter comprises a cache limit parameter, and
wherein the coding the attribute information is controlled based on controlling cache logic according to the cache limit parameter.

5. The method according to claim 4, wherein the controlling the cache logic comprises:
determining a cache limit point number threshold according to the cache limit parameter that limits a number of to-be-coded points to be written to the cache; and
reading the second intermediate coefficient from the cache for coding based on the number of to-be-coded points written to the cache reaching the cache limit point number threshold.

6. The method according to claim 5, wherein the reading the second intermediate coefficient comprises:
counting a first total number of points of at least one point cloud group written to the cache to be coded, and based on a second number of point cloud groups being written to the cache and the first total number reaching the cache limit point number threshold, reading a third intermediate coefficient of a third point of the at least one point cloud group from the cache for coding; or
counting a third number of the at least one point cloud group written to the cache, calculating a fourth total number of points written to the cache based on the third number and a point number limit threshold of the at least one point cloud group, and based on the fourth total number reaching the cache limit point number threshold, reading a fourth intermediate coefficient of a fourth point of the at least one point cloud group from the cache for coding.

7. The method according to claim 4, wherein the controlling the cache logic comprises:
determining, according to the cache limit parameter, a number threshold of point cloud groups to be written to the cache; and
based on a fifth number of point cloud groups written to the cache reaching the number threshold of point cloud groups, reading, from the cache for coding, the second intermediate coefficient.

8. The method according to claim 7, wherein the method further comprises arranging, according to a preset arrangement manner, a second plurality of point cloud groups written to the cache,
wherein the preset arrangement manner comprises a fixed arrangement manner or a dynamic arrangement manner,
wherein a first arrangement manner of intermediate coefficients of the second plurality of point cloud groups is fixed based on the fixed arrangement manner, and
wherein a second arrangement manner of intermediate coefficients of the second plurality of point cloud groups is not fixed based on the dynamic arrangement manner.

9. The method according to claim 8, wherein the preset arrangement manner corresponds to an index value, and
wherein the method further comprises writing a first index value corresponding to the preset arrangement manner in a coded code stream formed by the coding.

10. The method according to claim 4, wherein the coding the attribute information is controlled based on run-length coding, comprising:
determining, according to the cache limit parameter, a cache limit point number threshold limiting a number of points to be coded to be written to the cache;
setting, during the run-length coding, a first run-length used to count consecutive first type of symbols;
setting the first run-length to an initial value; and
sequentially reading a plurality of intermediate coefficients of a plurality of points to be coded from the cache, wherein:
based on a fifth intermediate coefficient whose value is a first type of symbol being read, increasing a count value of the first run-length by one step;
based on a first number of points to be coded that are read being equal to the cache limit point number threshold,
coding a current run-length, or
coding the cache limit point number threshold and a sixth intermediate coefficient of a sixth point to be coded whose value is the first type of symbol, and setting the first run-length to the initial value for recount; and
based on a seventh intermediate coefficient of a seventh point to be coded whose value is a second type of symbol being read,
coding the current run-length and the seventh intermediate coefficient of the second type of symbol, and
resetting the first run-length to the initial value for recount.

11. A point cloud processing apparatus, comprising:
at least one memory configured to store computer program code;
at least one processor configured to read the program code and operate as instructed by the program code, the program code comprising:
setting code configured to cause at least one of the at least one processor to set a limit parameter of a point cloud;
obtaining code configured to cause at least one of the at least one processor to obtain attribute information of a first point of the point cloud to be coded;
processing code configured to cause at least one of the at least one processor to code the attribute information of the first point; and
transmitting code configured to cause at least one of the at least one processor to transmit the coded attribute information in a code stream,
wherein the attribute information is coded in a controlled manner according to the limit parameter, and
wherein the limit parameter comprises at least one of a cache limit parameter or a delay limit parameter.

12. The apparatus according to claim 11, wherein the attribute information is coded based on a coding scheme in unit of a number of points,
wherein the processing code is configured to cause at least one of the at least one processor to:
convert the attribute information of the first point to obtain a first intermediate coefficient of the first point;
write the first intermediate coefficient to a cache; and
read the first intermediate coefficient from the cache for coding, and
wherein the first intermediate coefficient comprises a residual coefficient or a transform coefficient.

13. The apparatus according to claim 12, wherein the attribute information is coded based on a coding scheme in unit of a number of groups,
wherein the processing code is configured to cause at least one of the at least one processor to:
group attribute information of a plurality of points to be coded, to obtain a first plurality of point cloud groups;
convert attribute information of a second point of a point cloud group to be coded, to obtain a converted point cloud group;
write the converted point cloud group to a cache; and
sequentially read a second intermediate coefficient of the second point from the cache for coding, and
wherein the second intermediate coefficient comprises a residual coefficient or a transform coefficient.

14. The apparatus according to claim 13, wherein the limit parameter comprises a cache limit parameter, and
wherein the coding the attribute information is controlled based on controlling cache logic according to the cache limit parameter.

15. The apparatus according to claim 14, wherein the processing code comprises:
determining code configured to cause at least one of the at least one processor to determine a cache limit point number threshold according to the cache limit parameter that limits a number of to-be-coded points to be written to the cache; and
reading code configured to cause at least one of the at least one processor to read the second intermediate coefficient from the cache for coding based on the number of to-be-coded points written to the cache reaching the cache limit point number threshold.

16. The apparatus according to claim 15, wherein the reading code is configured to cause at least one of the at least one processor to:
count a first total number of points of at least one point cloud group written to the cache to be coded, and based on a second number of point cloud groups being written to the cache and the first total number reaching the cache limit point number threshold, read a third intermediate coefficient of a third point of the at least one point cloud group from the cache for coding; or
count a third number of the at least one point cloud group written to the cache, calculate a fourth total number of points written to the cache based on the third number and a point number limit threshold of the at least one point cloud group, and based on the fourth total number reaching the cache limit point number threshold, read a fourth intermediate coefficient of a fourth point of the at least one point cloud group from the cache for coding.

17. The apparatus according to claim 14, wherein the processing code comprises:
determining code configured to cause at least one of the at least one processor to determine, according to the cache limit parameter, a number threshold of point cloud groups to be written to the cache; and
reading code configured to cause at least one of the at least one processor to, based on a fifth number of point cloud groups written to the cache reaching the number threshold of point cloud groups, read, from the cache for coding, the second intermediate coefficient.

18. The apparatus according to claim 17, wherein the apparatus further comprises arranging code configured to cause at least one of the at least one processor to arrange, according to a preset arrangement manner, a second plurality of point cloud groups written to the cache,
wherein the preset arrangement manner comprises a fixed arrangement manner or a dynamic arrangement manner,
wherein a first arrangement manner of intermediate coefficients of the second plurality of point cloud groups is fixed based on the fixed arrangement manner, and
wherein a second arrangement manner of intermediate coefficients of the second plurality of point cloud groups is not fixed based on the dynamic arrangement manner.

19. The apparatus according to claim 18, wherein the preset arrangement manner corresponds to an index value, and
wherein the apparatus further comprises writing code configured to cause at least one of the at least one processor to write a first index value corresponding to the preset arrangement manner in a coded code stream formed by the coding.

20. A non-transitory computer-readable storage medium, storing computer code which, when executed by at least one processor, causes the at least one processor to at least:
set a limit parameter of a point cloud;
obtain attribute information of a first point of the point cloud to be coded;
code the attribute information of the first point; and
transmit the coded attribute information in a code stream,
wherein the attribute information is coded in a controlled manner according to the limit parameter, and
wherein the limit parameter comprises at least one of a cache limit parameter or a delay limit parameter.
